(19) United States
(12) Patent Application Publication
(10) Pub. No.: US 2008/0270166 A1
(43) Pub. Date: Oct. 30, 2008

(54) TRANSCRIPT, COURSE CATALOG AND FINANCIAL AID APPARATUS, SYSTEMS, AND METHODS

(76) Inventors: Duane Morin, North Andover, MA (US); Jason Ciruolo, Allston, MA (US); Gary Southard, Tewksbury, MA (US); Beryl Simon, Arlington, MA (US); Alexander D. Crosett, North Andover, MA (US); Sudeep P. Unhale, Brighton, MA (US)

Correspondence Address: K&L Gates LLP, STATE STREET FINANCIAL CENTER, One Lincoln Street, BOSTON, MA, 02111-2950, US

(21) Appl. No.: 12/103,968

(22) Filed: Apr. 16, 2008

Related U.S. Application Data
(60) Provisional application No. 60/923,707, filed on Apr. 16, 2007.

(51) Int. Cl. G06Q 10/00

(52) U.S. Cl. 705/1

(57) ABSTRACT

In one aspect the invention relates to a method of automating an application process. The method includes the steps of collecting student identification information using a graphic user interface; collecting student transcript and student application data; generating a first secure communication channel to transmit a portion of the student transcript and student application data to a first server in response to a valid request; formatting the transcript data such that it is suitable for use by a first database; generating a second secure communication channel to transmit the portion of the student transcript and student application data to the first database, the first database managed by a higher educational institution, and notifying the first server when the transcript data has been received by the database. In one embodiment, the valid request is verified using student identification information.

### CROSS REFERENCE TO RELATED APPLICATIONS

This application claims priority to U.S. Provisional Patent Application Ser. No. 60/923,707 filed on Apr. 16, 2007, the disclosure of which is herein incorporated by reference in its entirety. This application incorporates by reference in its entirety the disclosure of co-pending U.S. patent application Ser. No. 11/406,065.

### FIELD OF THE INVENTION

The invention relates to the field of automating the educational institution application process. Specifically, the invention relates to systems, devices, and methods for performing an application process, including the transcript processing, financial aid request and lending processes electronically.

### BACKGROUND OF THE INVENTION

The college application process is a complex and time sensitive endeavor with an unpredictable outcome. Furthermore, as the number of applicants far exceeds the number of class positions at many educational institutions, the application and selection process is also extremely competitive. Notwithstanding these hurdles, the costs of education continue to spiral upwards with each passing year. On a parallel track from the admission officer perspective, student transfers and wasted marketing efforts often make enrollment management expensive and inefficient.

As a result, the process of applying to educational institutions is often a time consuming and stressful process for prospective applicants and their families. Unfortunately, given the above-identified factors, in combination with the complexity of the student loan process, many applicants feel overwhelmed and poorly informed about the application and selection process. Accordingly, a need therefore exists for improvements in the process of applying to educational institutions. In particular, improvements that offer timesavings and reduce applicant anxiety are highly desirable. Additionally, as the process of applying for a position with a particular entity generates large volumes of information, methods for using that information are also of value.

### SUMMARY OF THE INVENTION

In general, aspects of the invention disclosed herein provide a software platform and various methods that significantly reduce the stress and cost associated with the process of applying to an entity such as an educational institution and the reciprocal process of admitting applicants to such an institution. A central portal for applying for, evaluating, and selecting financial aid is another aspect of the invention.

The following summary describes certain aspects and embodiments of the invention. It does not encompass every embodiment, and should not be construed as limiting the invention.

In one aspect, the invention relates to a method of processing and routing applicant data. The method includes the steps of collecting electronic profile data from a first applicant, the first applicant enrolled in a first institution, the electronic profile data includes a first grade point average associated with the first applicant; first applicant identifier data; and at least one test score. The method also includes the step of automatically transmitting the electronic profile data for the first applicant in response to a first request. The first request originates from one of a second institution or the first applicant. In addition, the method includes the steps of automatically generating an admission decision report with respect to the first applicant; and displaying one of the profile data for the first applicant or the decision report to a reviewing party associated with the second institution.

In one embodiment of this method, the first institution and the second institution are selected from the group consisting of a high school; a community college; a 2-year post-high school institution; a trade school; a college; a university; a 4-year post-high school institution; a scholarship program; a graduate school; and an employer. In another embodiment, the method further includes the step of accessing an electronic course catalog generated in response to historic transcript data to obtain a first set of course catalog data for the first student. In yet another embodiment, the method further includes the step of calculating a second grade point average for the first applicant in response to the first set of course catalog data.

In one aspect, the invention relates to a method of processing academic transcript data. The method includes the steps of transmitting electronic transcript data for a first student in response to a request, the electronic transcript data having an associated first grade point average; accessing an electronic course catalog generated in response to historic transcript data to obtain a first set of course catalog data for the first student; and calculating a second grade point average for the first student in response to the first set of course catalog data. In one embodiment, the method further includes the step of making one of an admit, deny, or hold decision for the first student based on the second grade point average. The electronic transcript data can be transmitted in an XML format and other formats as appropriate. In another embodiment, the method further includes the steps of collecting electronic application data from the first student; transmitting the electronic application data to an educational institution; and transmitting an electronic admit, deny, or hold decision to the first student.

In another aspect, the invention relates to a method of processing financial aid applications. The method includes the steps of presenting a sequence of questions to an applicant using a computer based graphic user interface, changing the questions in the sequence presented as a function of the answers given by the applicant, the questions developed in response to a plurality of financial aid applications; populating a plurality of electronic financial aid forms using the answers provided to the sequence of questions; and transmitting the plurality of electronic financial aid forms to their originating institutions. In one embodiment, the method is implemented using a financial aid aggregator portal such that a process for submitting financial aid requests to a plurality of entities and a process of notifying an applicant of aid awards are performed using the portal. In another embodiment, the method further includes the step of generating a hierarchical representation of financial aid awards on a per educational institution basis using a single portal having a graphic user interface. Similarly, in yet another embodiment, the method further includes the step of identifying financial aid awards on a per institution basis using a single interface.

In yet another aspect, the invention relates to a method of processing electronic transcript data. The method includes the steps of receiving student transcript data on a periodic basis for a first school; identifying a plurality of courses in response to the student transcript data; generating an electronic course catalog that includes a plurality of course entries, the course catalog accessible using an interface; updating the course catalog as new student transcript data is received; and alerting an educational institution when the course catalog changes. In one embodiment, applicant or student data can include, but is not limited to, tests, profiles, immunization, school profile, class profile etc. Although the terms student transcript data, student identification information, applicant data, student record and student application information are used throughout, the use of any of these terms is meant to include the scope of the other and not otherwise limit the invention to particular type of student information or record.

In still another aspect, the invention relates to a method of automating an application process. The method includes the steps of collecting student identification information using a graphic user interface; collecting student transcript and student application data; generating a first secure communication channel to transmit a portion of the student transcript and student application data to a first server in response to a valid request; formatting the transcript data such that it is suitable for use by a first database; generating a second secure communication channel to transmit the portion of the student transcript and student application data to the first database, the first database managed by a higher educational institution, and notifying the first server when the transcript data has been received by the database. In one embodiment, the valid request is verified using student identification information.

Although the terms college, university, and academic institution are used throughout, the use of any of these terms is meant to include the scope of the other and not otherwise limit the invention to a particular type of academic or non-academic institution.

An advantage of one aspect of the invention is that academic institutions can develop a substantially paperless admission program that offers improved efficiency by targeting those students that are not likely to transfer and that are likely to perform well academically.

The logic, process flows, methods and systems disclosed herein are not limited to higher education institutions alone. The techniques disclosed herein can be extended to any application process, such as a home loan or a job application. The document matching and data format approaches described herein to match applicant data associated with multiple electronic documents such that the receiving party can have a complete and accurate applicant file are extendible to all application processes. Further, the scope of this invention applies to information transfer between any two institutions where these institutions are any type of elementary school, middle school, high school, college, university, academic institution or a partner institution, whether academic or non-academic in nature.

Various embodiments and figures of the present invention include non-limiting references to the systems, interfaces, software and other technical features offered by ConnectEdu or provided at www connectedu.net as exemplary implementations or embodiments of the invention. The references to Connect, Connect!, ConnectEdu, or any related network or internet based technologies relating thereto (or those of any acquirer or successor in interest), as used or referenced herein, are not intended to be limiting, but instead represent certain general and preferred embodiments.

In one aspect, embodiments of the invention are implemented using a system based on a multi-tiered architecture. The system includes internal and external data interfaces/services/modules and collections of subsystems with a central web based user interface and other data interfaces for integration with various target and host systems. In part, the system includes a data load module/service/software component that enables data loading and validation. The web portal components of the system includes a web interface suitable for integrating and interacting with a financial planning system, a curriculum planner system, an enrollment management system, a transcript management system, a letter of recommendation (LOR) management system, a GPA recalculation system, interfaces for connecting with other internal and external applications, and a content management system. The overall system also includes, but is not limited to including: a transcript web service/data service, a Letter of Recommendation web service/data service/module, an EDI transcript module/service, a data warehouse/backend database, an enrollment management service/module, and a Course Catalog Service/module.

In part, the invention relates to a software platform for addressing the college placement process. The college placement platform connects a plurality of users, including, but not limited to counselors, students, parents, teachers, letter of recommendation authors, high school administrators in an access controlled community environment. The methods empower college counselors while simultaneously ensuring that students have a customized application process and college selection solution. Similarly, the methods disclosed herein streamline and/or eliminate administrative tasks so that counselors, parents and applicants are comfortable with the application process and achieve their admission objectives.

In one aspect, the invention relates to a method of simplifying an educational institution application process. The method includes a plurality of steps. In part, the method includes dividing the educational institution application process into a plurality of sub-processes, and arranging a portion of the plurality of sub-processes in response to a scheme. In some embodiments, the scheme is a calendar or a logical arrangement of steps. The method also includes the steps of collecting user profile data in response to a plurality of queries, the queries selectively presented to the user in response to a branching logical hierarchy; and generating a report in response to the profile data.

In one embodiment of this aspect, the report is indicative of a trend of interest to the educational institution or an action item the user must satisfy to advance an aspect of the educational institution application process. Additionally, in another embodiment, the method further includes the step of alerting the user to critical milestones. In another embodiment, the method provides access to vendor services in response to a user inquiry. The method further includes the step of delivering targeted content to the user in response to user profile data in one embodiment. Alternatively, in yet another embodiment the invention further includes the steps of screening users and restricting user access to a class of users defined by a relationship to participating partner firms. The report is a financial aid application form in one embodiment. However, in another embodiment the report is selected from the group that includes a scholarship application, a 529-application form, a student loan application, a list of potential colleges, and/or a college application plan.

In another aspect, the invention relates to a method of supporting a user's application process to an educational institution. The method includes a plurality of steps. In particular, the method includes developing a profile for the user through a sequence of questions, the questions presented through a graphic user interface and presenting a set of possible answers to each question such that selection of a given answer triggers the next question in the sequence. The method also includes correlating the answers to each question to an admission profile for the educational institution; selecting educational institutions for the user to apply to based on likelihood of success; and instructing the user with at least one of a strategy or a action item reminder to improve their likelihood of application acceptance.

In one embodiment, the relationship between the questions and answers is based on a set of college application process rules and/or historical user profile data. The educational institution can be a financial aid institution. In addition, the financial aid institution can be a federal agency.

In general, in one aspect, the invention relates to a method of targeting a user participating in an application process. The method includes the steps of generating a plurality of application process objects, each object having an object profile; comparing the profiles of different objects to determine correlations between objects; determining a demographic profile about one or more users in response to correlations between objects and historical object profiles; and delivering content to a user having the demographic profile.

In one embodiment of this aspect, the application process is a college selection process. Additionally, in another embodiment a partner company pays for delivering content to the user having the demographic profile. The correlation of this aspect can be determined using a filtering technique. Alternatively, in one embodiment the partner company is a student loan provider.

In another aspect, the invention relates to a method of selecting applicants for admission to an academic institution. The method includes the steps of collecting retention data and admission profile data for a plurality of admitted applicants; correlating admission profile data to determine which applicants remain at the academic institution and graduate to identify a graduating applicant profile; and admitting students having an admission profile to the academic institution, wherein the admission profile is substantially correlated with the graduating applicant profile. In one embodiment, the method further includes the step of directing marketing materials to prospective applicants that substantial match one or more criteria associated with a graduating applicant profile. The method can also include the step of establishing a dialogue with prospective applicants that substantial match one or more criteria associated with a graduating applicant profile.

In yet another aspect, the invention relates to an enrollment management system adapted for selecting students for admission to an academic institution. The system includes a database, and a user interface in electronic communication with the database adapted for searching for prospective applicants. The database includes applicant profile information and applicant retention information. The system also includes a user interface for prospective applicants to communicate with admissions officers and a data analysis module for correlating applicant retention information and applicant profile information to identify prospective applicants that have a reduced likelihood of transferring from the academic institution after admission. The applicant retention information can include transfer statistics for one or more admitted students. The prospective applicants that have a reduced likelihood of transferring from the academic institution can be evaluated in comparison to an overall applicant pool for a given admission cycle.

In still another aspect, the invention relates to a method of recommending an academic institution to a prospective applicant. The method includes the step of collecting admission data about the applicant. The admission data includes applicant criteria. The method includes the steps of calculating a GPA for the applicant; assigning weights to the criteria; scoring academic institutions in response to the weighted criteria; and generating a tiered list of academic institutions, the tiered list includes academic institution listed in descending order of goodness of fit with the prospective applicant.

In still yet another aspect, the invention relates a method of applying for a student loan. The method includes the steps of collecting student identification information using a graphic user interface, the graphic interface associated with a first server; determining financial need in response to a financial aid interview; selecting one of a plurality of lending institutions from a display screen; populating an automated loan application form associated with the selected lending institution using the identification information, the automated loan application associated with a second server, querying the student user for any missing student loan application information; and submitting a completed student loan application to the selected lending institution. In one embodiment, the student user is pre-qualified for a student loan in response to the user completing a portion of a college application. The plurality of lending institutions can be displayed to a user in response to a demographic parameter specified by at least one lending institution. In addition, a security identifier can be associated with the second server is used to establish a secure channel between the first and second servers.

In another aspect, the invention relates to an automated student information system. The system includes a database configured to store applicant profile data. The applicant profile includes a first grade point average associated with a first applicant; first applicant identifier data; and at least one test score. The system also includes an electronic transcript processing module in electrical communication with the database. The electronic transcript processing module configured to receive an electronic transcript from the first applicant's enrolled institution. In addition, the system includes a student information system interface. The interface in communication with the database and configured to automatically retrieve and process applicant data to prepare an admit, deny, or hold decision report. In one embodiment, the enrolled institution is selected from the group consisting of a high school; a community college; a 2-year post-high school institution; a trade school; a college; a university; a 4-year post-high school institution; a scholarship program; a graduate school; and an employer.

The details of one or more embodiments of the invention are set forth in the accompanying drawings and the description below. Other features, objects, and advantages of the invention will be apparent from the description, drawings and examples, and from the claims.

### BRIEF DESCRIPTION OF THE DRAWINGS

FIG. 1 is a schematic drawing of a software and hardware based system suitable for performing the electronic transcript, GPA standardization, course catalog, enrollment management, application process, centralized portal, and other methods and other features disclosed herein according to an illustrative embodiment of the invention;

FIG. 2 is a flow chart identifying a plurality of steps for course catalog delivery according to an illustrative embodiment of the invention;

FIG. 3 is a screenshot depicting a login screen suitable for accessing a browser based embodiment of the invention;

FIG. 4 is a non-limiting exemplary format for representing or using information according to an illustrative embodiment of the invention;

FIG. 5A-5D are screenshots depicting interfaces suitable for specifying admission requirements and processing data used in GPA calculations to an illustrative embodiment of the invention;

FIGS. 5E-5G are screenshots depicting interfaces for interacting with or creating a course catalog, course planner, or curriculum planner according to an illustrative embodiment of the invention;

FIGS. 5H-5I are block diagrams of two examples relating to admit, deny, hold reports generated to streamline the application evaluation process according to an illustrative embodiment of the invention;

FIG. 6 is a schematic drawing of another system suitable for performing the electronic transcript, GPA standardization, course catalog, enrollment management, application process, centralized portal, and other methods and other features disclosed herein;

FIG. 7 is a flow chart identifying a plurality of steps for transcript and/or letter of recommendation delivery using a secure file transfer based protocol according to an illustrative embodiment of the invention;

FIGS. 8A, 8A′, 8B, and 8C are schematic diagrams depicting workflows for transmitting student data electronically according to an illustrative embodiment of the invention;

FIG. 9 is a flow chart identifying a plurality of steps for transcript and/or letter of recommendation delivery using a web service based approach to an illustrative embodiment of the invention;

FIGS. 10A-10C are schematic diagrams depicting workflows for transmitting student data electronically according to an illustrative embodiment of the invention;

FIGS. 11A-11C are non-limiting exemplary formats for representing or using information according to an illustrative embodiment of the invention;

FIGS. 12A-12C are screenshots depicting interfaces for an interactive financial planner and manager according to an illustrative embodiment of the invention;

FIGS. 13A-13C are screenshots depicting interfaces for an interactive financial planner and manager such that the scholarships can be evaluated and applied for according to an illustrative embodiment of the invention;

FIG. 14 is a screenshot depicting an interface for an interactive budget plan according to an illustrative embodiment of the invention;

FIG. 15 is a schematic diagram depicting a workflow for a centralized financial aid application and fulfillment process according to an illustrative embodiment of the invention; and

FIGS. 16A-16K are screenshots depicting interfaces suitable for use with the workflow of FIG. 15 and other embodiments described herein according to an illustrative embodiment of the invention:

### DETAILED DESCRIPTION

The following description refers to the accompanying drawings that illustrate certain embodiments of the invention. Other embodiments are possible and modifications may be made to the embodiments without departing from the spirit and scope of the invention. Therefore, the following detailed description is not meant to limit the present invention. Rather, the scope of the present invention is defined by the appended claims.

In part, aspects of the invention relate to a comprehensive, interactive technology solution for a broad class of users engaged in the college preparation, search, application and financial aid process. In part, the aspects of the invention relate to software solutions that automate electronic transcript processing, GPA standardization, enrollment management, the application process, and application processing. Further, the invention also provides an electronic course catalog, a course planner, a financial planner, and a centralized portal to carry out and interact with the various features and methods described herein. However, the techniques disclosed herein are extendible to any application process for a position of interest.

In general, some of the aspects of the invention disclosed herein are methods and systems that operate using a software platform, such as a web services, generic data services, or data feeds, system to automate the college admissions process, the college application process, the financial aid application process or all three. In general, one feature of the different embodiments described herein is to make existing time intensive processes substantially paperless and thus reduce cost by improving processing speeds. Although various aspects and embodiments of the invention are discussed below, they generally fall into three broad categories of solutions. These categories include electronic transcript processing and transmission, an electronic implementation of a course catalog on per a per institution basis, and a financial aid solution that aggregates all aspects of the process when applying, reviewing awards, and selecting aid packages. Typically, these categories of systems can be implemented using one portal having a graphical user interface.

### Substantially Paperless Admissions Decisions and Application Submission

Moving student information from one institution to another has historically been a labor intensive and costly task. Each new technological development advertises a more cost efficient and effective means to process documents received during the admissions process when compared to managing a paper delivery process. However, the ultimate goal of a “paperless” admissions office has remained an aspiration and not a reality. Unfortunately, admissions offices have discovered that the benefits of deploying new solutions often provide lower return on investment as these solutions reveal areas of complexity, cost and labor intensity that are unknown until after the purchase has been made and often post implementation. These solutions do not eliminate paper, the associated labor, and the technical issues, but rather create extra steps in the process.

Web services applications, data services, data feeds, and various suitable browser and non-browser based platforms, as described herein, as aspects of the invention, allow for an electronic exchange of data from one student information system (high school or community college) to another (four year college) without ever creating a paper document at any point in the process. These services also eliminate the need for re-keying of data. An aspect of the invention employs a web services solution that addresses the problems associated with the approaches attempted to date. However, prior to considering the aspects of the invention in detail, it is useful to evaluate the other approaches and their deficiencies.

An investigation of the admissions application materials processing function at several institutions that have deployed allegedly cost saving technology solutions was performed. To avoid bias, various types of colleges and universities were included in the initial study so that variances between public and private institutions, and those that receive high and low volumes of admissions applications could be taken into account. Considered in the investigation were the initial reasons each institution used in making the decision to purchase a technology based solution, and the evaluation of the effectiveness of achieving the goals after deployment.

This resulted in five document-processing criteria. They are as follows:

Labor Intensity Number of staff needed to perform the tasks, the amount of time to complete the tasks and difficulty of each task.

Processing Risks Risks associated with lost or misfiled documents, delays due to volume of materials and the timeliness of status updates with applicants.

Data Accuracy Number of mistakes due to data entry errors, misfilings, and the difficulty to correct the errors along with the associated consequences of committing the error for the admissions applicant population.

Security Risks Potential exposure of student data during the process and in transmission of admissions application materials.

Budgetary Impact Cost of hardware, software, need for more or less staff, and ongoing maintenance fees associated with licensing agreements.

Time studies were performed for each solution and compared with the time to process an entire admissions application and related materials using the paper-based manual processing method as a baseline. This evaluation provided a true view of the “time” savings afforded to an admissions office by deploying each solution compared to the manual process.

With respect to admissions application materials processing tasks, broad categories were devised for reporting purposes and simpler comparison between solutions. These broad categories included:

Document Arrival: Time associated with receipt of documents, initial sorting and distribution, printing of electronically received documents if applicable (i.e. pdf files).

File Creation Time associated with the creation of the file folder, coding, sorting and filing of documents, gathering of previously received documents, recalculation of GPA, and distribution to data entry staff.

Data Entry Time associated with keying of data into the Student Information Systems for all documents associated with an applicant's file, and correcting data entry error.

Maintenance: time associated with the continuous maintenance of a file as additional documents are received, decisions made and movement through the process.

Lastly, each solution was evaluated based on the observed outcomes in terms of:

Cost to Implement: Hardware and software purchases, labor, training costs, and difficulty of the implementation.

Ease of Use: Ease at which staff can adopt the solution and the daily effort needed to fulfill the tasks.

Ability to Provide a Paperless Office: How close to the ultimate goal did the solution advance the operation of the admissions office?

Data Accuracy Improvement: Improvement of data accuracy in the student information system and document management.

Cost Effectiveness How did the office view the overall return on investment vs. the initial goals?

Automation and Verification: How does the solution allow for automation of recalculation of GPA and verification of student identity and matching data?

### Traditional Paper Method

From the perspective of both sender and receiver, moving paper admissions application materials through the mail is the most labor-intensive process. In addition to the high labor cost of these manual procedures, the security and processing risks both remain high. With each added step is the risk of processing delays, lost documents and input errors.

### EDI Technology

Sending documents using Electronic Data Integration (EDI) technology significantly reduces the processing risks and increases the accuracy of the data when the information moves from one Student Information System (SIS) to another without the manual re-keying step. EDI also creates a more secure process with less points of exposure. Unfortunately, EDI requires both the sender and the receiver to deploy the same software and hardware, or the same EDI format standard, which limits usability. Additionally, the data upload process utilizing EDI data protocols requires a heavy investment in IT programming on the front end. EDI also requires manual staff management on the back end of the upload process to ensure data conformity, load reliance and system acceptance.

### Portable Document Format (.pdf) Method

The .pdf method can reduce security and processing risks by eliminating the points of exposure and the cost associated with mailing, but increases the cost with the purchase and upgrade of hardware and software necessary for both sender and receiver. However, sending .pdfs via email or in open registration models is dangerous and open to security breaches. Ultimately, the receiving college admissions office is still unable to extract the data locked in each document electronically, which makes the automatic recalculation of GPAs and matching of applicant materials impossible. One aspect of the invention addresses this problem.

The .pdf becomes a paper document after receipt and the task of re-keying the data into the college SIS falls upon the admissions staff. Additionally, this solution needlessly burdens the students with the cost of sending the .pdf and has limited use in terms of making all admissions application materials paperless.

### Imaging/Scanning Technology

Imaging technology allegedly replaces the manual re-keying process at the receiving end. Added training, software and hardware are simply substitutes for the manual re-keying process and cost. Data accuracy is at high risk because scanned images must be clearly legible and in a compatible format to be recognized electronically. Further, data that has been captured by OCR technology must be verified to ensure accuracy. Therefore, instead of eliminating labor-intensive costs, this technology reallocates it to the creation and maintenance of document templates and the verification processes.

### Software and Services Solutions

Aspects of the invention can be implemented using various software platforms and data services, such as some of the web services solutions and other solutions to the problems discussed herein. Using web services solutions, as one aspect of the invention, to send admissions application materials electronically is an efficient, cost-effective and secure method. According to one embodiment, uploading data directly from a SIS onto secure servers, reformatting the deliverable file to adhere to industry standards supported by the Post-secondary Education Standards Council (PESC) (or other institution specific format) and securely delivering them to the receiving student information system reduces multiple processing steps. With no printing, mailing, processing, re-keying or imaging, there are no delays, no errors and no security risks, resulting in the ability to reduce labor costs. Unlike the other solutions discussed above, web services provide the flexibility for customized delivery of documents and data in EDI or .pdf format if required. The other solutions do not lend themselves to a web services delivery model such that automatic GPA recalculation and applicant submitted material matching is possible. With a comparatively low upfront investment of staff time, and no long-term maintenance contracts, the overall impact on the budget is minimal and contributes to an unprecedented return on investment.

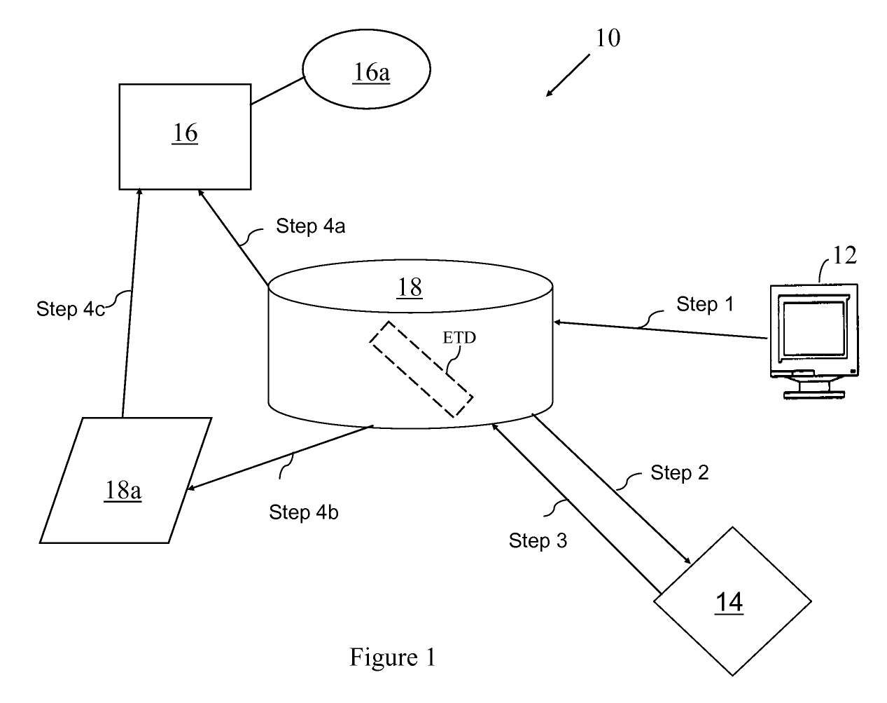

A web services solution provides greater efficiencies and a positive impact on the admissions offices processing of application materials. Further, a web services solution reduces labor time, minimizes risks, eliminates data entry, and moves the admissions office towards the goal of a truly paperless office. By eliminating many of the steps in the application process, data entry errors, lost documents and security risks are significantly reduced. In terms of a return on investment, the labor savings alone are enough to build a business case for adoption of the web services solution. A typical college admissions office can reduce the cost to process an entire admissions application and related materials by an average of $25.38/applicant. For an office that receives 10,000 applications per year, the result is an annual savings in excess of $253,000 per year. Additional savings occur by eliminating significant costs for hardware, software and the related maintenance charges. Finally, the complicated implementations of many of the available solutions are avoided. In light of the benefits associated with a web services based solution, it useful to explore a general system embodiment of the invention suitable for implementing a web services based approach and other automated approaches. Such a general system embodiment is depicted in FIG. 1.

Until now, the process of sending, receiving and processing admissions application materials has been an arduous and expensive task. Utilizing web services to send data and documents in true electronic form from one SIS to another is the most cost-effective and efficient method available today. Web services allow secondary and post secondary institutions to be united in their efforts to share data, including all admissions application related materials (i.e. transcripts, letters of recommendation, essays, applications, financial aid applications) with the security and ease that's never been achieved before without using paper at any point in the process.

### Electronic Transcript, Letter of Recommendation, and Course Catalog Delivery

One aspect of the invention, as shown in FIG. 1, includes a network based software application, such as an Internet based web services implementation, and information service system, generally an application process data exchanging system 10. In one embodiment, one or more web servers implement aspects of the exemplary system 10. Various modules, subsystems, programs, clients, databases, interfaces, browsers and operating systems are also suitable for use in the system 10 in various embodiments.

As shown in FIG. 1, a user 12 (with access to a computer) may be a student at a presently attended (or previously attended) educational institution such as, but not limited to a high school or a community college. The presently attended institution may have a database or student information system, in general a software platform 14 that contains data about the student user 12. Typically, the student user 12 is in the process of applying to a higher educational institution, such a four-year college or university. The higher educational institution can have an associated student information 16 or enrollment management system 16. The higher educational system may include specific modules, programs, per applicant report generating functionality, or business logic (generally 16a). For example, according to one aspect of the invention, the higher educational institution may use business logic 16a as part of the admit, deny, hold decision-making process to reduce the workload of admission officers processing applicants such as the user 12.

In accordance with one embodiment of the invention, the user 12 accesses a browser, a client, dummy terminal, or other suitable application to transmit data to and receive data from an interactive student data processing application 18, such as a web services application, or other software application. The application may be resident on one or more servers, the user's computer, or the higher educational institutions system 16. In one embodiment, the application 18 helps the student user complete relevant tasks for their college search and application process. Electronic applications, tools, and resources are dynamically introduced to a user based upon their specific profiles using the application 18. High school guidance counselors can use the application 18 to manage the college admission process at their school. In addition, college admission officers use the application 18 or their system 16 to evaluate students and potentially make admit, deny, or hold decisions in an electronic environment.

The student data processing application 18 may include an electronic course catalog as a module (not shown) or connect to a separate electronic course catalog 18a. Historically, high schools do not generate and do not update course catalogs. Accordingly, an electronic high school course catalog that is created using electronic transcripts such that they provide the mechanism for populating a database integrated with a web services system or other data delivery system to create the course catalog is one aspect of the invention.

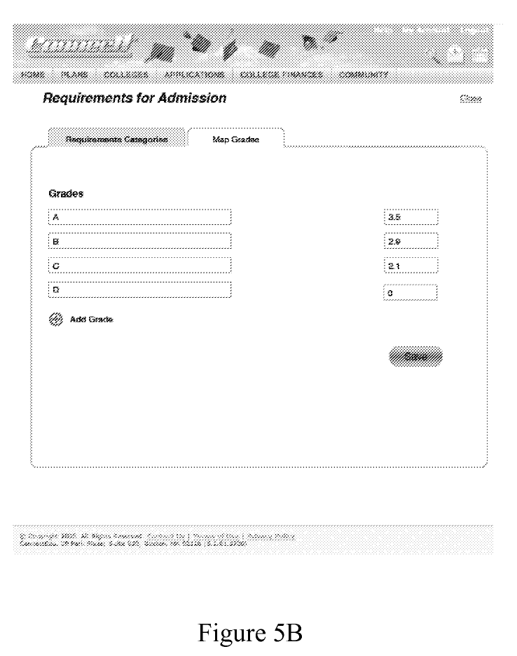

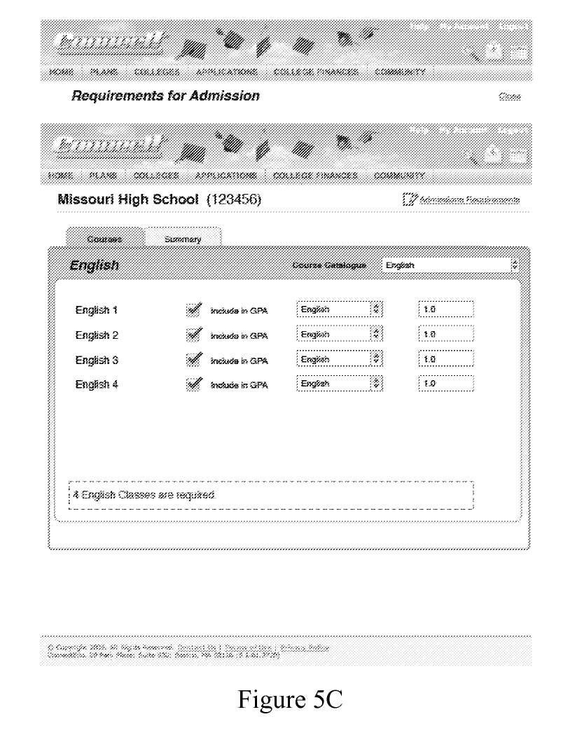

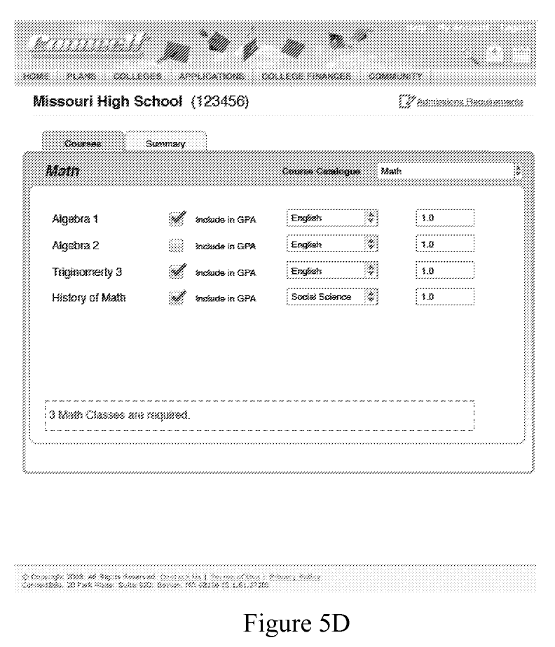

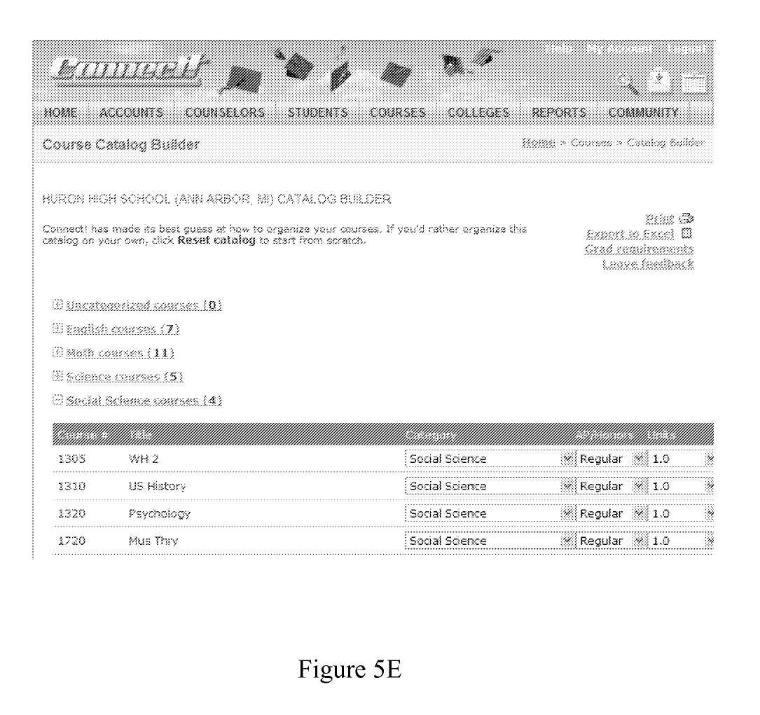

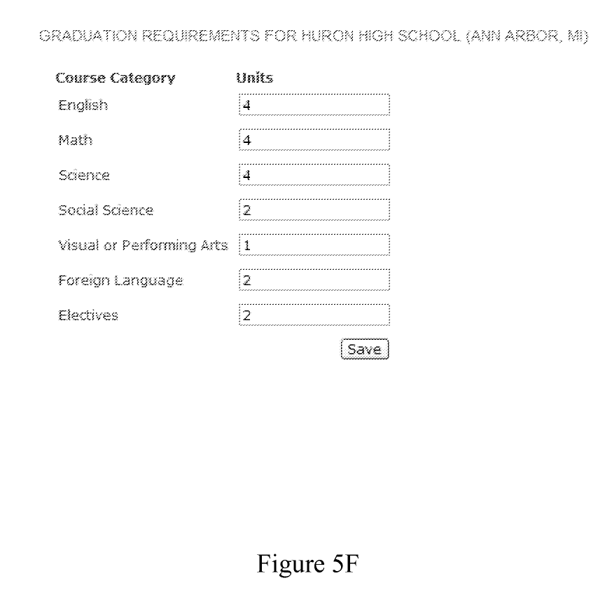

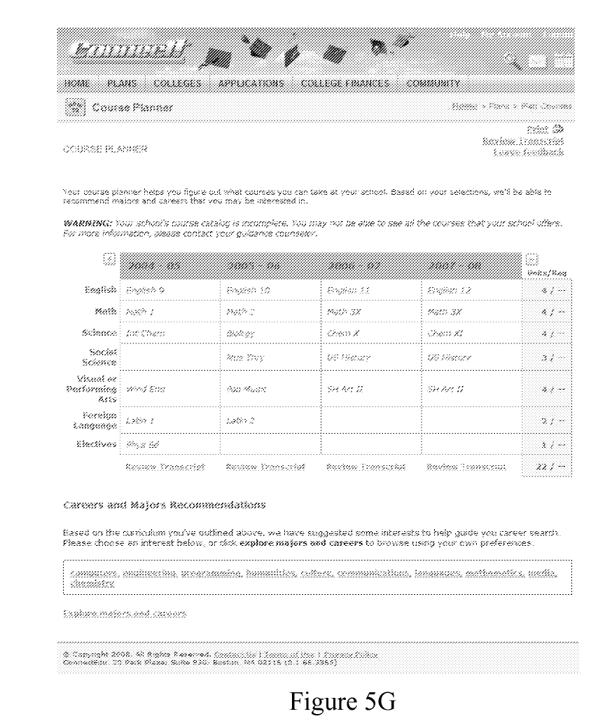

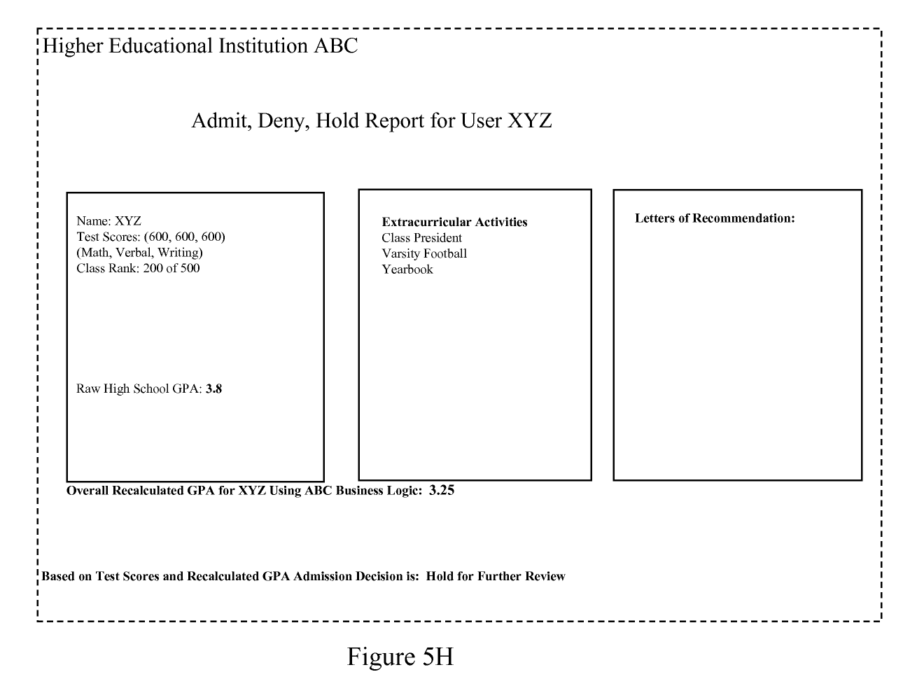

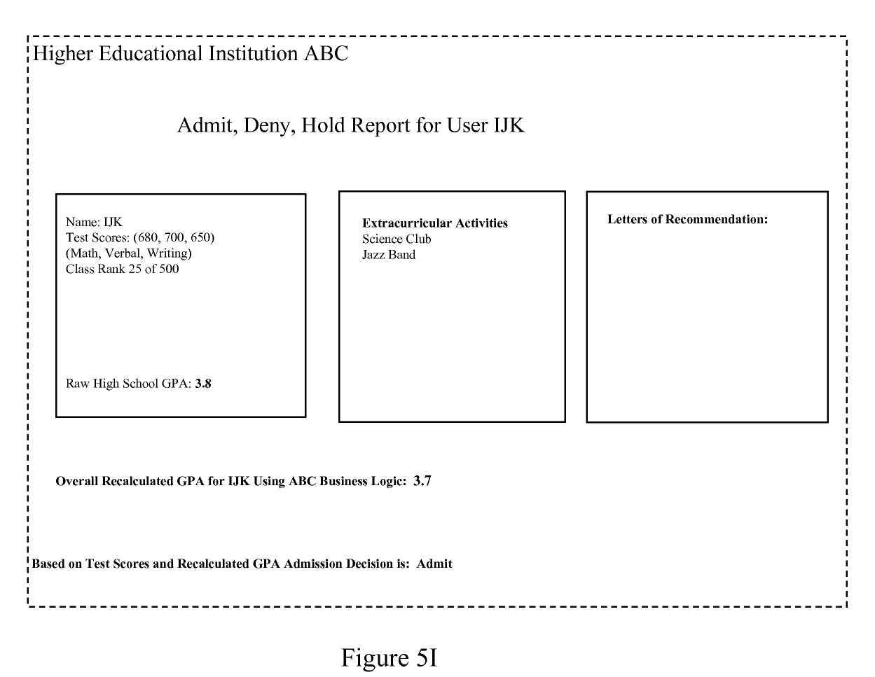

In one embodiment, the electronic course catalog enhances the higher educational institution's ability to use electronic transcript data (ETD). This functionality is discussed in more detail below. Specifically, to process a user's GPA, the course catalog enables individual filters or rules to be formulated by colleges that convert each students' GPA to another GPA that is specifically tailored to the college's internal admission criteria. This second GPA is a more refined metric for the admit, deny or further consideration decisions required for a pool of applicants. Additional details relating to GPA recalculation are discussed below with respect to FIGS. 5A-5D. As a general example, if a school does not wish to include athletic classes or wishes to increase the weight for advancement placement classes, the interactive interface described herein allows classes to be weighted or excluded at the discretion of the relevant institution.

The course catalog module (and transcript module) can also include various reporting and filtering functionality. Specifically, a user can request all course catalogs for the given list of institution codes. In turn, this reporting can be coupled with a filtering process. For example, a user, such as a requesting institution can request all of the course catalogs for desired institutions that satisfy a particular set of criteria such that the criteria is not limited to course category, course type, course credit type, course title, etc. Thus, the course catalog module can be used to generate various reports and data sets of interest to institutions. The same type of querying, filtering and reporting can be performed relative to transcript data.

As shown in FIG. 1, the different features of the overall system 10 automate the college application process. For almost all college applications, sending a copy of an applicant's current academic transcript for the institution they are presently or were previously attending is required. For the reasons discussed above, implementing a paperless transcript submission system is of significant value to both the applicant and the higher educational institution that receives and evaluates the transcript. Therefore, to understand the interrelationships and interactions between the various entities in the system 10 depicted in FIG. 1, a high-level description of an exemplary electronic transcript request and submission process is informative. Further, as this ETD based approach is one aspect of the invention, a description of an exemplary electronic transcript data workflow will demonstrate enhancements relative to current transcript solutions.

As shown in FIG. 1, initially a user 12 requests (Step 1) that a first academic institution, such as their high school or community college send electronic transcript data to the higher educational institution to which the user 12 is applying. As show, this request is performed using an application 18 that is typically resident on a server. Although the first communication channel depicted is between the user 12 and the application 18, in other embodiments the user 12 can contact their high school or other institution and the school. In turn, a counselor can communicate with the application 18 to initiate the process. In either instance in one embodiment, no transcript data is sent from the first institution without an approval and verification process as to the requester's identity. Additional details relating to this are described in the specific examples and implementations provided below.

Once the application 18 receives a request from a user, or other authorized entity, it opens a communication channel with the first institution's information management system 14, requests the transcript data (Step 2) and performs any necessary verification/registration procedures. The information system 14 of the first institution typically includes a database with the relevant transcript data. In response to a valid request, the information system 14 relays the electronic transcript data (ETD) (Step 3) to the application 18 in the format maintained at the first institution. Instead of emailing a pdf of the transcript data, uploading a record, or using an EDI approach the transcript data is sent to the application 18 using a specific approach. Specifically, the transcript information can be encoded in a structured document format. One suitable format is Xtensible Markup Language (XML). The XML format is desirable in some embodiments because it allows the document to describe itself and its contents to the receiving system, including information necessary to match that student information with other application materials used by the institution evaluating the student for admission.

In general, if additional information about a student applicant 12 is available, it is also transmitted with the formatted electronic transcript (F-ETD) data in some embodiments. Examples of the relevant data that may accompany student data such as transcript data include the student's date of birth, general information about the profile of the relevant institution, such as a high school or community college attended, student letters of recommendation, and information about the type of grading system and marking system used.

A profile of an institution, such as the high school from which the ETD or F-ETD is being sent, can be electronically sent as a part of transcript data (or student record) using the application 18. Alternatively, the profile can be sent by another software platform, a centralized aggregation portal, a data service, a web service, a hosted application, a desktop application, or using another suitable technology. A non-limiting example of an electronic educational institution profile (high school in given example) that may be included with the transcript data, student information, or student record is as follows.

```
<ConnectOrganizationalCatalog>
    <Profiles>
        <Profile>
            <Organization>
                <ATP>234567</ATP>
                <OrganizationName> High School</OrganizationName>
                <Contacts>
                    <Address>
                        <AddressLine>400 Masters Ave</AddressLine>
                        <City>Hannil</City>
                        <StateProvince>MO</StateProvince>
                        <PostalCode>63401</PostalCode>
                        <CountryCode>US</CountryCode>
                    </Address>
                    <Phone>
                        <AreaCityCode>573</AreaCityCode>
                        <PhoneNumber>2222333</PhoneNumber>
                    </Phone>
                    <Phone>
                        <AreaCityCode>573</AreaCityCode>
                        <PhoneNumber>2223311</PhoneNumber>
                        <NoteMessage>Fax</NoteMessage>
                    </Phone>
                    <Email>
                    <EmailAddress>counselor@hannil.edut</EmailAddress>
                    </Email>
                    <URL>
                        <URLAddress>http://www.hannil.edu
</URLAddress>
                    </URL>
                </Contacts>
            </Organization>
            <!-- Electronic document approval since date -->
            <ElectronicallyApprovedDate>2007-11-
06</ElectronicallyApprovedDate>
            <!-- Type of organization -->
            <OrganizationType>High School</OrganizationType>
            <!-- public organization indicator -->
            <PublicOrg>Yes</PublicOrg>
            <!-- Grade required for passing -->
            <PassingGrade>2.5</PassingGrade>
            <!-- Block scheduling indicator-->
            <BlockSchedule>No</BlockSchedule>
            <!-- Block schedule type-->
            <BlockScheduleType>No block schedule</BlockScheduleType>
            <!-- Weighted GPA indicator-->
            <WeightedGPA>Yes</WeightedGPA>
            <!-- School year term type-->
            <TermTypeCode>4</TermTypeCode>
            <!-- School year term Name-->
            <TermType>Quarter</TermType>
            <!-- Advanced Placement indicator-->
            <APDesignation>AP</APDesignation>
            <!-- Honors indicator-->
            <HonorsDesignation>Hon</HonorsDesignation>
            <!-- Advanced Placement courses offered -->
            <APOfferedCourses>12</APOfferedCourses>
            <!-- Honors courses offered -->
            <HonorsOfferedCourses>4</HonorsOfferedCourses>
            <!-- International Baccalaureate indicator-->
            <IntBaccDesignation>IB</IntBaccDesignation>
            <!-- International Baccalaureatecourses offered -->
            <IntBaccOffered>0</IntBaccOffered>
            <!-- Percentage of students planning to attend 2 yr. college -->
            <PctPlanAttendTwoYr>10</PctPlanAttendTwoYr>
            <!-- Percentage of students planning to attend 4yr. college -->
            <PctPlanAttendFourYr>65</PctPlanAttendFourYr>
            <!-- Source of Accreditation -->
            <Accredidation>New England Association of Schools and Colleges, Inc.
(NEASC)</Accredidation>
            <!-- Last year's average ACT Score -->
            <AvgLastYrACT>25</AvgLastYrACT>
            <!-- Last year's average ACT Composite Score -->
            <AvgLastYrActComp>26</AvgLastYrActComp>
            <!-- Last year's average SAT Reading Score -->
            <AvgLastYrSATReading>560</AvgLastYrSATReading>
            <!-- Last year's average SAT Math Score -->
            <AvgLastYrSATMath>570</AvgLastYrSATMath>
            <!-- Last year's average SAT Writing Score -->
            <AvgLastYrSATWriting>550</AvgLastYrSATWriting>
            <!-- Last year's average SAT Combined Score -->
            <AvgLastYrSATTotal>26</AvgLastYrSATTotal>
        </Profile>
    </Profiles>
</ConnectOrganizationalCatalog>
```

Thus, the application 18 transmits (and receives confirmatory receipts of) student information, such as electronic transcript data, electronic application data, letters of recommendation, and other relevant data, between the first institution (the institution being applied from) and the second institution. Rather than requiring that each transcript or other data receiving institution adopt a proprietary data format in common with the application 18 or each high school or community college, the application 18 sends electronic transcript data (Step 4a) to the second institution's information system 16 according to that system's preferred format. Thus, the second institution's information system 16 receives the electronic transcript data in a suitable format for populating the relevant databases for that institution's enrollment management decision-making process (admit, deny, hold, etc.).

Typically, the second institution's information system 16 opens a communication channel with the application 18 to notify the application 18 that the second institution (the institution being applied to) received the transmitted data. In turn, the application 18 relays a similar notification to the user 12. Although the steps described above illustrate an aspect of the invention relating to transcript submission, there is another problem relating to the use of electronic transcript data that has remained unsolved to date. The use of an electronic course catalog as discussed in more detail below solves this problem.

In one embodiment, the electronic course catalog platform is derived from the transcript data and from data related to the first or sending institution's operational database. High school course catalogs can be made available using a web server using an XML format. A user can download course catalogs from the application 18 to an XML file or from a stand-alone catalog 18a. In one embodiment, access to the electronic course catalog requires a login and password or other verification mechanism. Further, in one embodiment, a central course catalog includes course catalogs for a plurality of high schools organized by the high school's ATP code or other suitable indexing mechanism.

In one embodiment, searching the course catalog queries the database for all courses on record at a given school. These courses have some record of at least one student attending the class and receiving a grade. Conversely, if the school offers a particular course, but the system has no transcript records from any student taking the course, then it would not appear in the downloaded course catalog.

In one embodiment, the course catalog includes, but is not limited to: identifying information about the school (name, address, city, state, etc); the course number for each course; all names applied to that course (for example, US History, U.S. History), to track minor name changes that may occur from year to year; and other relevant course data. However, in various embodiments other data can be included, such as all courses that could have been taken in lieu of each class listed on a transcript.

The course catalog data refines the student information available from a transcript and creates a list of courses available at a school. College admissions officers can use this information to evaluate school transcripts and recalculate students' grade point averages to conform with their admissions standards. Officers can perform this analysis without manually crossing out and recalculating individual applicant grade point averages.

Since the application 18 interfaces with a particular first educational intuition's information system 14 coupled with the application's receipt of ETD, in one embodiment, the application 18 assembles the raw data for an electronic course catalog on a per school basis. In one preferred embodiment, the course catalog is provided using a web services implementation. Using the available transcript data for all of the students in a particular school allows a course catalog to be populated using all courses taken that were distinct for each participating high school.

There are many uses for such an electronic course catalog. However, before considering some of the secondary uses, it is useful to consider all of the benefits when integrated with the higher educational institution's information services 16. From a higher educational institution perspective, the electronic course catalog provides many significant uses and advantages. These include integrating the course catalog 18a with an information system and the institution's business logic to perform the GPA recalculation processes automatically as part of a batch process.

For example, as part of its business logic 16a, a higher educational institution can develop an updateable set of business rules as part of a table or a relationship to create a mapping of what courses are acceptable from a particular high school or community college. For each student, the transcript data that has been received is processed using the programmed business logic 16a. In addition, the systems and techniques disclosed herein convert the first GPA to a second GPA. The second GPA is a better reflection of what a particular high educational institution deems valuable. Further, the second GPA allows for the relative comparison of all applicants using a common scale or set of GPA assumptions. In instances where a numeric score and GPA are insufficient to determine and admission outcome, the business logic 16a and the information system 16 (or application 18) can be adapted to generate specific reports that include transcripts with captions from course catalogs to make them more easily compared and evaluated by admissions officers. Alternatively, the relevant classes an applicant could have taken, but chose not, can be listed in a caption for a given admissions offers report. Further, if multiple high school's all offer a math 400 class, the electronic implementation of the course catalog can be used to automatically factor out this name or to supply captions such that an admissions officer can determine what these course names actual correspond to in terms of what was taught in the course.

Once a higher educational institution makes the investment in maintaining business logic to automate the process of calculating new modified grade points averages based on the course catalog 18a, the underlying method of building the course catalog 18a provides a further advantage in terms of alerts and feedback. Specifically, since the course catalog changes on a quarterly, per semester, or other period when new courses appear in the student transcript data (Step 4b), the course catalog software can be adapted to alert the higher educational institution about these new courses (Step 4c). This is a benefit to the educational institutions because if they have already invested in the business rules, it is necessary to keep them up to date as course catalogs change over time. An electronic course catalog, such as a data or web services implementation, provides this updated functionality.

There are many secondary uses for the electronic course catalog described above and in further detail below. For example, since catalogs of this type have not existed to date, parents can access it in advance of course selection and provide input with regard to the classes their children take in high school. Further, from the student perspective, the application 18 can generate a guide for a particular student based on which college or university they are applying to or what major they may wish to pursue. In turn, the application 18 can then automatically identify which courses they should take in their high school or community college. In addition, as the data that is used to build the course catalog comes directly from the applicant's school, the college need no longer make phone calls to individual schools to ask questions. This feature reduces one source of error in the admission process.

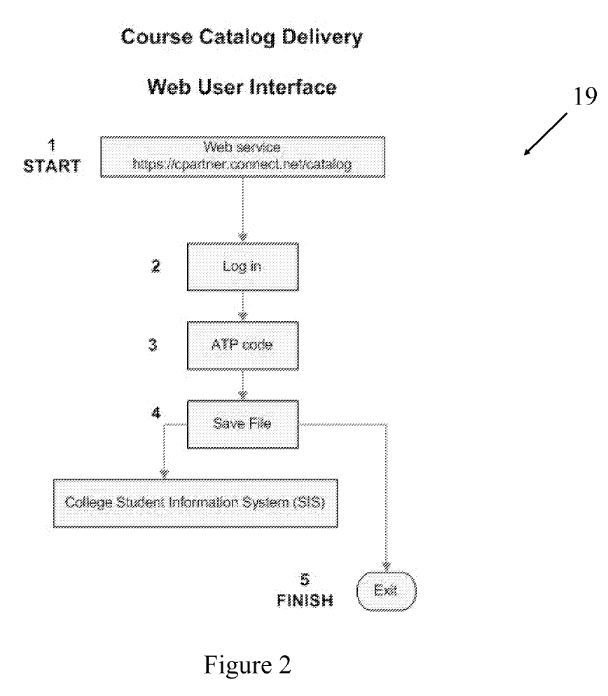

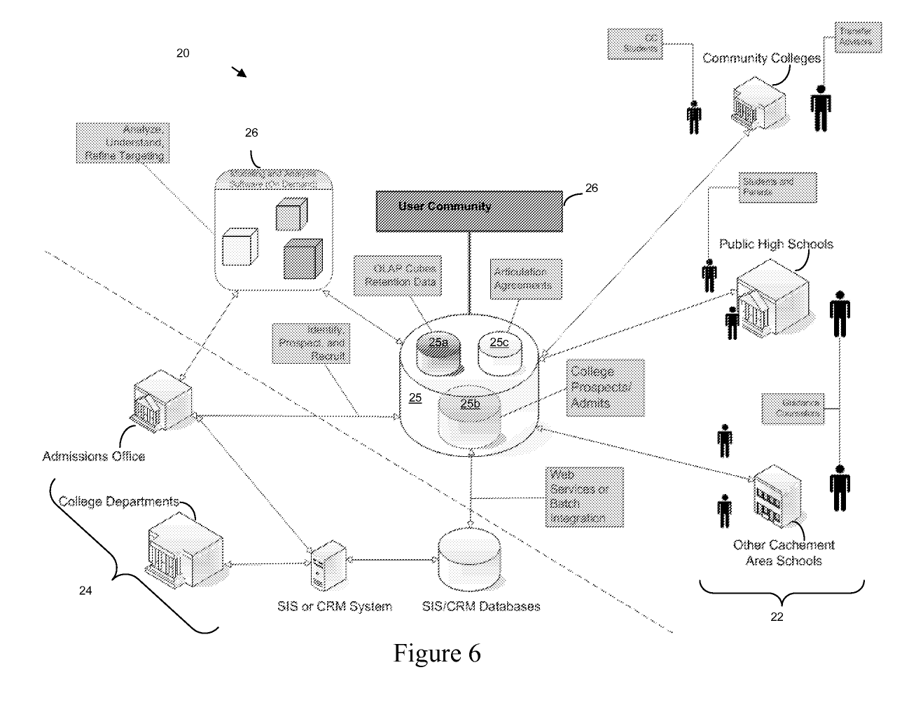

Although different embodiments of the electronic course catalog are discussed herein, it useful to consider some of the process flow steps from a web user interface based approach. An exemplary process flow for course catalog delivery is shown in FIG. 2 and in more detail in FIG. 6A, discussed below. Typically, the course catalog is configured for business and security reasons such that a user of the catalog is partnered with a particular high school, university, or an entity that is managing an overall system (10 or 18). As shown in FIG. 2, the flow chart 19 illustrates a delivery workflow for a course catalog according to one embodiment of the invention.

As shown in the flow chart 19, the first step for this exemplary process flow is to connect to the web service. For this particular embodiment, the course catalog is downloadable using a web interface. However, in other embodiments a programmatic web service can be used. A programmatic web service differs from the present embodiment in that a web services client at another location on the Internet can retrieve and consume data from the course catalog for use by other software or data collection services.

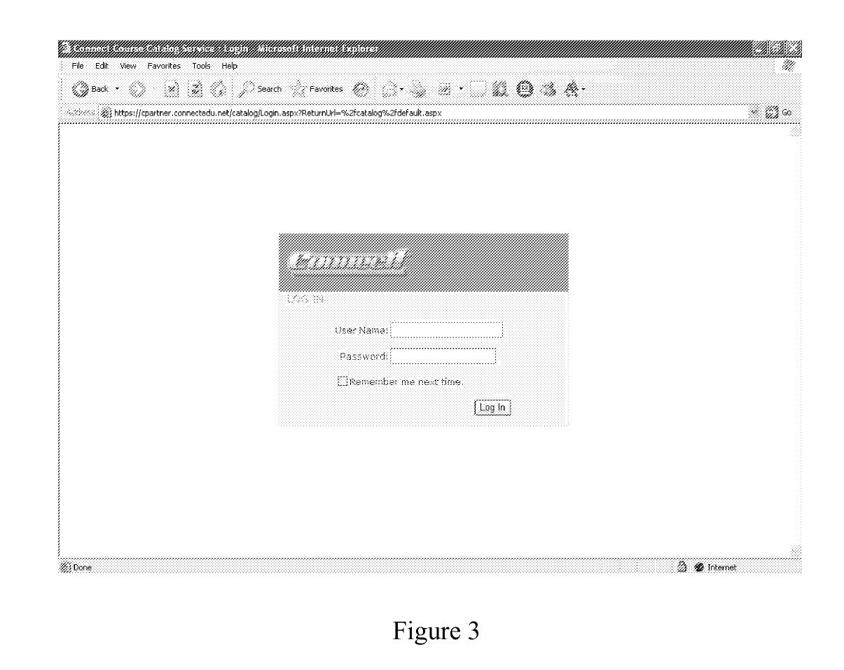

To connect to the web service as shown in step 1, the user starts his or her browser and accesses a particular internet address, such as https://cpartner.connectedu.net/catalog. For security reasons, and to regulate the level of access available to different users, the course catalog may require a login, step 2. Typically, the login requires a user name and password to access the service. An exemplary login screen is shown below in FIG. 3.

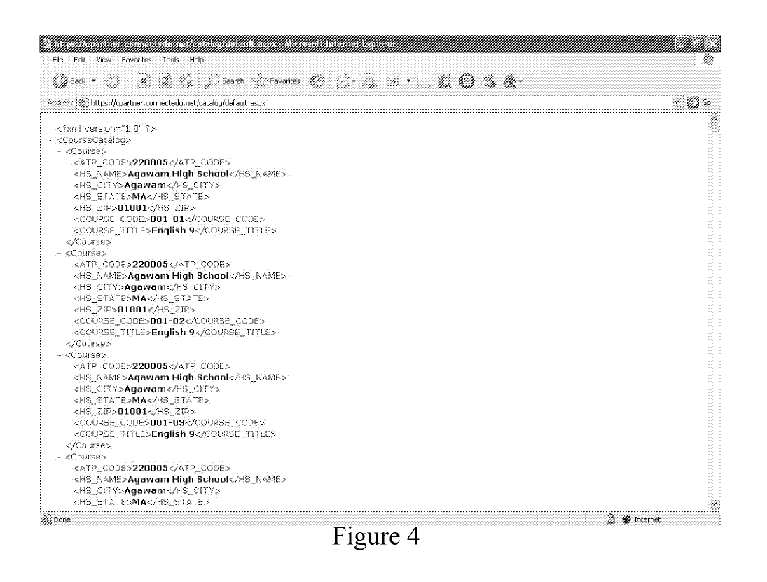

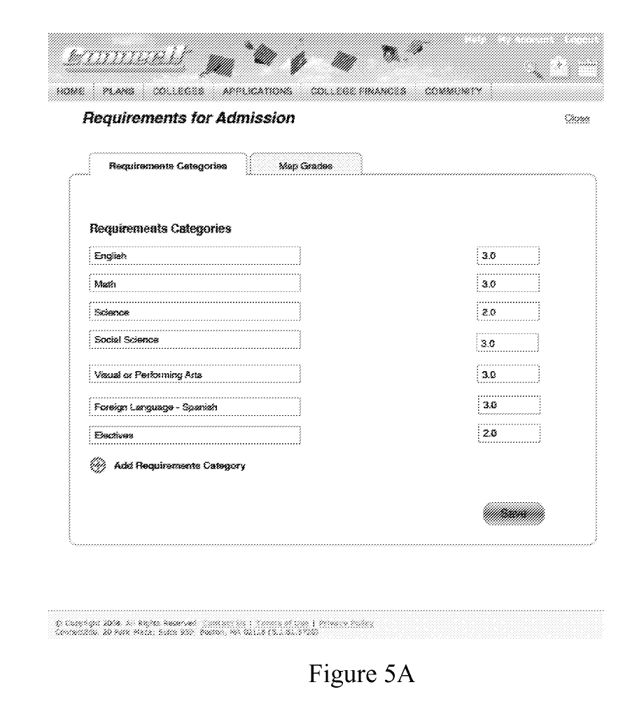

In one embodiment, the next step, step 3, is to Enter ATP code. This follows because in the embodiment depicted every school in the catalog is identified by an American Testing Program or ATP code. The user can either type a single ATP code to retrieve the course catalog for one school or type 0 (zero) to retrieve all course catalogs currently available. However, other formats and indices for organizing schools are possible. Next, the course catalog loads into the browser in XML format. An example of a portion of a suitable XML format is shown in FIG. 4.

The user can elect to save (Step 4) the relevant catalog or catalogs as a file to a local drive. An exemplary format for a course catalog file is shown in FIG. 4. Specifically, the user can use the Save As command on the File menu to save the file in XML or XSL format. When done, the user closes the browser and exits the web service. In other embodiments, a user can browse each course catalog and run specific queries.

Various software-based data service and web service approaches can be used to implement a locally or remotely accessible course catalog. As an example, a course catalog web service application programming interface (API) can be used to by the institution to support client side integration. The following table summarizes the programmatic web services methods for downloading the course catalog for a educational institution like high school. However, this API can be extended to any educational institution. This example is for one embodiment and the parameters and requirements specified in this example and all other examples support particular embodiments, but do not constrain the invention only to those examples. The left column is the title of a program, routine or software module used by the relevant embodiment, the right column is a summary of some its functionality.

| Method | Summary |
|---|---|
| Login | Validates credentials against the web service |
| | and generates a time-sensitive sessionkey. |
| | The sessionkey must be used within 30 |
| | minutes, or it will time out. |
| | Note: In one embodiment, there is no separate |
| | login method for downloading transcripts, |
| | letters of recommendation, course catalog and |
| | candidate information for enrollment |
| | management. In one embodiment, the same |
| | login credentials are used, and the same |
| | session key could be used either for transcript |
| | or recommendation letter queries. |
| GetCourseCatalogs | Downloads course catalogs for the institution |
| | codes (for example, an ATP code for a high |
| | school). |
| | The result is a list of all course catalogs, which |
| | represent the course information, institution |
| | profile information, institution graduation |
| | requirements and other related information: |
| | If the result is 0 (zero), then there are no |
| | institutions with a course catalog ready to |
| | download and the user can exit. |
| | If the result is greater than 0 (zero), then |
| | there is at least one course catalog ready to |
| | download for one of the requested institutions. |
| | The result may be an XML output or in |
| | any other machine-readable format. |
| GetCourseCatalog | Downloads a course catalog for a given |
| | institution code (for example, an ATP code for |
| | a high school). |
| | The result is a course catalog, which represent |
| | the course information, institution profile |
| | information, institution graduation |
| | requirements and other related information: |
| | If the result is 0 (zero), then there is no |
| | course catalog ready to download for a given |
| | institution and the user can exit. |
| | If the result is greater than 0 (zero), then |
| | there is a course catalog ready to download for |
| | one of the requested institutions. |
| | The result may be an XML output or in |
| | any other machine-readable format. |
| | It is possible to transmit criteria for |
| | filtering the result set for this web method. |
| | That is, in one embodiment, parameters can be |
| | included to filter the result set based on the |
| | requesting institution's requirement. |
| GetCourseCategories | Downloads the information of the default |
| | course category containers as defined in the |
| | Connect system for a given institution code |
| | (for example, an ATP code for a high school). |
| | The result may be an XML output or in |
| | any other machine readable format. |
| | It is possible to transmit criteria for |
| | filtering the result set for this web method. |
| | That is, in one embodiment, parameters can be |
| | included to filter the result set based on the |
| | requesting institution's requirement. |
| GetCourseCategorized- | This will download the course catalog |
| Courses | information for the courses present in a given |
| | transcript. The transcript may be indicated |
| | using a transcript ID number or any other |
| | identifier. |
| | The result may be an XML output or in |
| | any other machine-readable format. |
| | It is possible to transmit criteria for |
| | filtering the result set for this web method. |
| | That is, in one embodiment, parameters can be |
| | included to filter the result set based on the |
| | requesting institution's requirement. |
| IsIntegrated | Returns a Boolean indicator to indicate if an |
| | institution represented by an institution code |
| | (for example, an ATP code for a high school) |
| | is integrated with the Connect platform/ |
| | system. |

Although a web services based approach can be used as outlined above, in addition to various other software-based approaches, course catalog information can be implemented using XML in one embodiment. An example of a course catalog information XML code portion suitable for supporting Customer Relationship Management/SIS integration with an educational institution to support the enrollment decision process follows.

(The data points are not limited by the ones shown in this example)

```
<ConnectCourseCatalog>
<CourseCatalogs>
        <CourseCatalog>
            <IsImplemented>True</IsImplemented>
            <Organization>
                <ATP>230086</ATP>
                <OrganizationName> High School </OrganizationName>
                <Contacts>
                    <Address>
                        <AddressLine>272 Fuller Road</AddressLine>
                        <City>Ann Arbor</City>
                        <StateProvince>MA</StateProvince>
                        <PostalCode>48105</PostalCode>
                        <CountryCode>US</CountryCode>
                        <AttentionLine></AttentionLine>
                    </Address>
                    <Phone>
                        <AreaCityCode>777</AreaCityCode>
                        <PhoneNumber>9999999</PhoneNumber>
                    </Phone>
                    <Email>
                        <EmailAddress>jdrew@high.edu</EmailAddress>
                    </Email>
                    <URL>
                    <URLAddress>http://www.highschool.edu</URLAddress>
                    </URL>
                </Contacts>
            </Organization>
            <GraduationRequirement>
                <CourseCategories>
                    <CourseCategory>
                        <Name>Math</Name>
                        <Units>4</Units>
                    </CourseCategory>
                    <CourseCategory>
                        <Name>English</Name>
                        <Units>3</Units>
                    </CourseCategory>
                    <CourseCategory>
                        <Name>Science</Name>
                        <Units>4</Units>
                    </CourseCategory>
                    <CourseCategory>
                        <Name>Social Science</Name>
                        <Units>2</Units>
                    </CourseCategory>
                    <CourseCategory>
                        <Name>Visual or Performing Arts</Name>
                        <Units>1</Units>
                    </CourseCategory>
                    <CourseCategory>
                        <Name>Foreign Language</Name>
                        <Units>1</Units>
                    </CourseCategory>
                    <CourseCategory>
                        <Name>Electives</Name>
                        <Units>3</Units>
                    </CourseCategory>
                </CourseCategories>
            </GraduationRequirement>
            <Courses>
                <Course>
                    <CourseNumber>AL-01</CourseNumber>
                    <!-- Name/Title of the course offered -->
                    <CourseTitle>Algebra I</CourseTitle>
<!-- Level of the course offered , Regular, Honors, AdvancedPlacement etc.-->
                    <CourseLevel>Regular</CourseLevel>
                    <!-- Units assigned by the counsellor for each course-->
                    <CourseUnit>1</CourseUnit>
                    <CourseCategory>Math</CourseCategory>
                    <!-- Type of the credit that the course is offered -->
                    <AcademicCreditType> Quarter </AcademicCreditType>
                    <!-- Minimum credits that the course is offered for -->
                    <MinCredits> 3.0 </MinCredits>
                    <!-- Maximum credits that the course is offered for -->
                    <MaxCredits>3.0</MaxCredits>
                    <!-- Free form description of the course -->
<CourseDescription>Intermidiate Algebra</CourseDescription>
                    <!-- Indicator to imply if the course is actively offered-->
                    <IsActive>True</IsActive>
                </Course>
            </Courses>
        </CourseCatalog>
    </CourseCatalogs>
</ConnectCourseCatalog>
```

As discuss above, at present, in many higher educational institutions, much of the application process is a paper-based system. It is a common sight to see rooms full of paper in university admission offices throughout the country. Unfortunately, this paper-based system requires a lot of manual calculations and research on the part of the admissions officers. Much of this additional work surrounds the evaluation of applicant transcripts.

Specifically, higher educational institutions develop an understanding about particular feeder schools and other schools in general. Thus, if an admissions officer knows that a particular math class associated with a particular school is not sufficiently rigorous, the officer may elect to strike it from a particular applicant's transcript. This process is performed on a case-by-case basis and transcripts for individual applicants are recalculated by hand. As a result, if the particular policy of a higher educational institution is to ignore creative writing, from any high school or community college, then the grade associated with that class is factored out in all applicable transcripts. Next, all of those transcripts need to have a new GPA calculation performed by hand and the resulting new GPA manually entered into that second educational institutions information system. This is a time consuming and inefficient process.

Furthermore, although colleges and universities maintain detailed course catalogs, high schools do not. Therefore, if an admissions officer wants to find out what a particular course on a transcript means, they need to call the high school and find out. For example, if an applicant from a school has “Advanced Math” and “Advanced Accounting.”

Although an initial read may cause the officer to think these classes correspond to a calculus or functions based class and an advanced business class, the officer needs to call the school. If the officer's assumptions are incorrect they may strike the classes and recalculate the GPA to make a more informed admissions decision. This is a labor intensive and costly exercise. In addition, relying on phone calls to high schools to analyze transcripts can lead to various types of errors and misinformation. An electronic course catalog 18a associated with the application 18 described above addresses these problems.

In addition, as discussed below in more detail, FIGS. 5A-5D depict interfaces associated with methods and processes that facilitate GPA recalculation and use of the electronic course catalog data to help remedy the problems identified above. These approaches use an electronic course catalog in various embodiments. FIG. 5A shows an interface suitable for specifying or adding admission requirements for specific courses, such as a Calculus I, or categories of specific courses such as English. Thus, in one embodiment, courses that fall outside the filters implemented in response to the user interface of FIG. 5A may be excluded from a recalculated second applicant GPA. In turn, in FIG. 5B an interface to map grades to a scale is illustrated. As shown, an A is mapped to a 3.5 instead of a 4.0, while a D is mapped to 0. The ability to tailor GPA recalculation gives an admission officer greater control in sorting applicants from schools with different GPA scales. With respect to FIG. 5C, an interface to map courses having different course names, (English 1-English 4) from an electronic course catalog to different categories of classes. Finally, in FIG. 5D, an interface to indicate the inclusion or exclusion of non-desired courses for GPA recalculation where the courses are from an electronic course catalog is shown.

FIGS. 5E-5G are screenshots of a user interface suitable for interacting with an electronic course catalog and for curriculum planning at an educational institution such as a high school, 2-year college, or other suitable curriculum based institution. These interfaces can be used to communicate with an electronic course catalog and to route student course selections, and other student information, to an end user or another educational institution. As shown in FIG. 5E, an interface for viewing course categories by a counselor or officer at a sending institution, such as a high school from which an applicant is applying to another institution, is depicted. In FIG. 5E a course catalog as been built based on available student transcript data. In one embodiment, the invention relates to processing a set of electronic transcript data to generate a set of course data and assembling the course data with an interface to create an electronic course catalog.

Further, FIG. 5F depicts an interface to add or update the graduation requirements by the counselor or officer at sending institution. Finally, an interface for parents and students to view their curriculum plan is shown in FIG. 5G. As shown in FIG. 5G, the curriculum plan identifies the relevant time periods of attendance at the high school and the course to be taken to graduate and otherwise focus on an area of interest. This plan can also include courses that are required by the colleges, universities, scholarship programs, etc. to which the student seeks to apply. Thus, the interface shown in FIG. 5G also serves to guide parents and student with respect to course selection requirements based on target institution, major, career or interest. These various interfaces augment the functionality of different system embodiments and enhance the user experience for applicants and admission officers alike.

Returning to FIG. 1, in light of the different features of the system 10, there is another general use for the system 10. As the college or university information system 16 receives the transcript data and other student data, the associated business rules 16a can be configured to generate reports for admissions officer according to another aspect of the invention. The enrollment management system discussed below with respect to FIG. 6 can also automatically generate such admit, hold, and deny type reports.

Two high level examples of such reports follow in Example 1 and Example 2, shown in FIGS. 5H and 5I, respectively. Given the many pieces of information that the application 18 can relay to the college information system 16, a report can serve as a basis for making an admit, deny, or hold decision for a given application. In Example 1, shown in FIG. 5H, the lower class rank and the difference between the submitted GPA and the second GPA calculated using course catalog data and the university's business rules has led to an overall “hold decision” for user XYZ. In contrast, in Example 2, as shown in FIG. 5I the higher class rank, the high GPA, and the closeness of the first GPA and the second GPA calculated by the university lead to an automatic “admit decision” for user IJK.

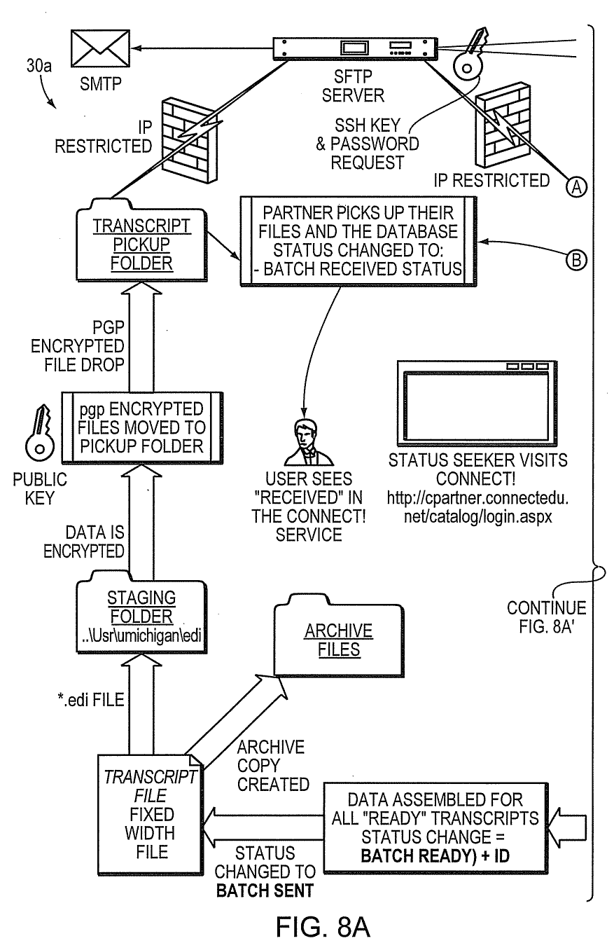

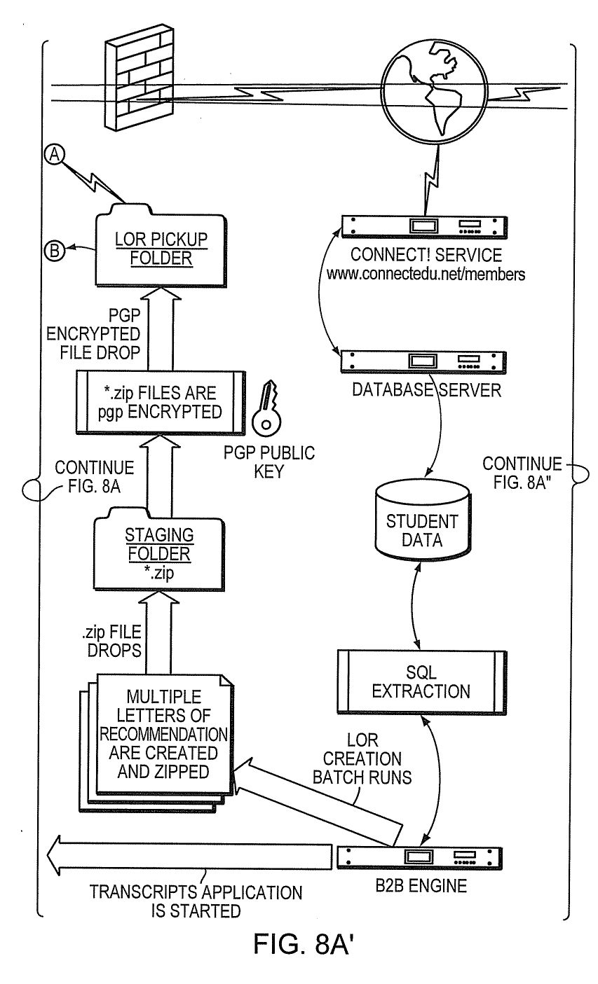

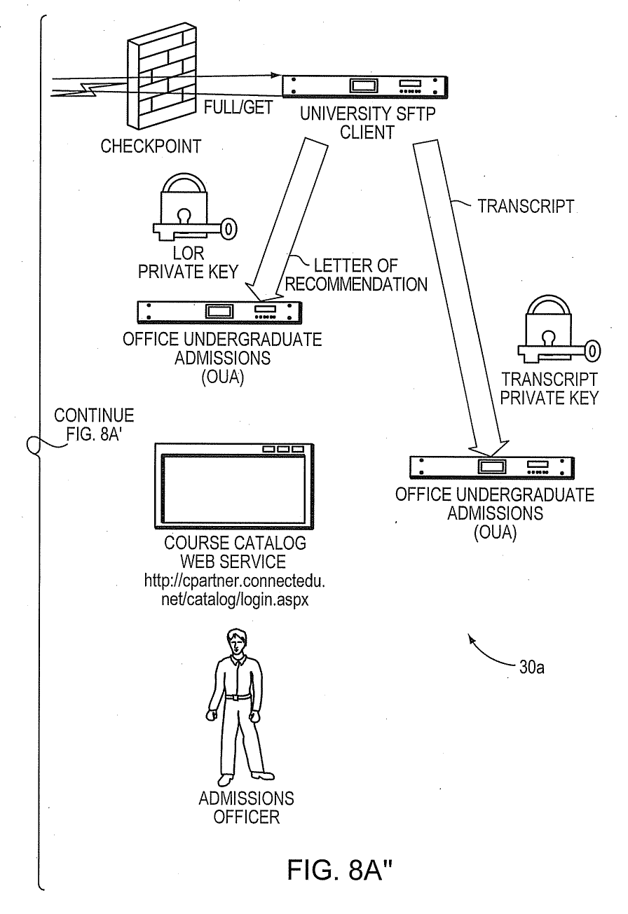

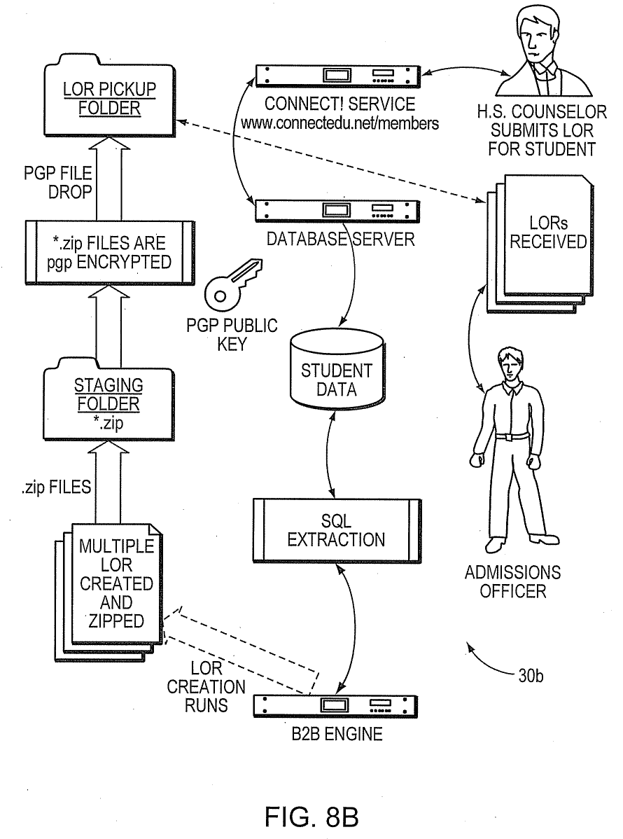

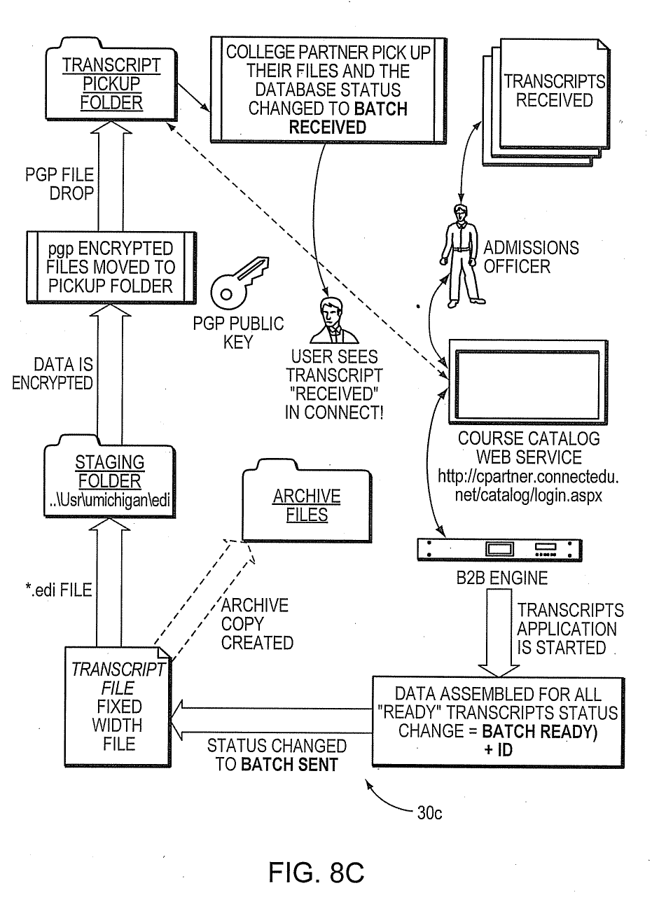

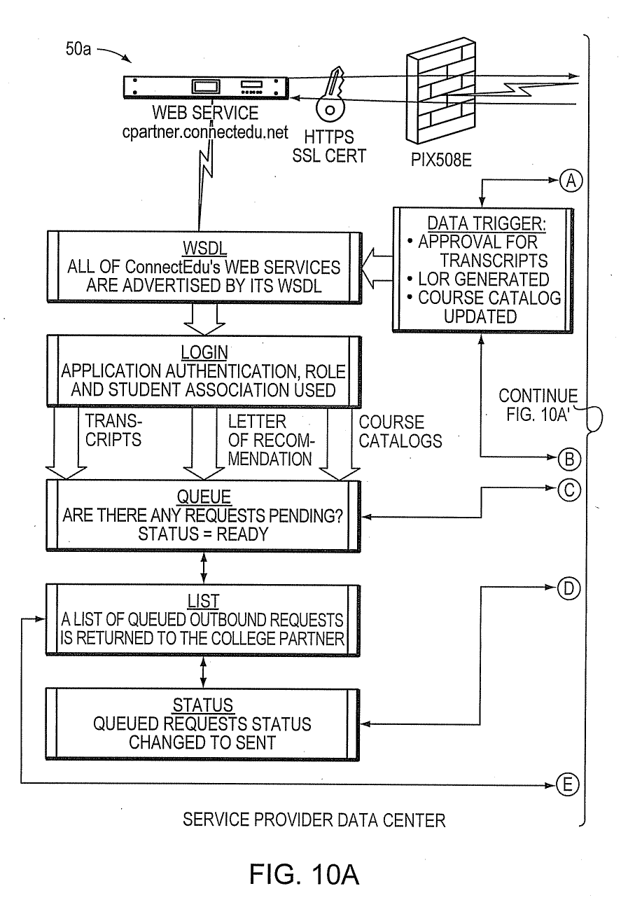

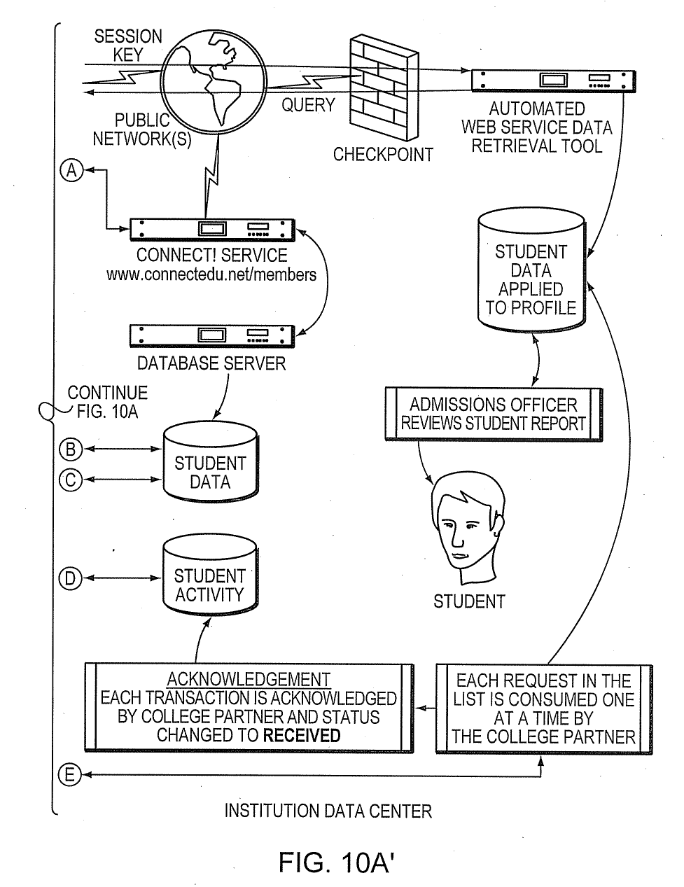

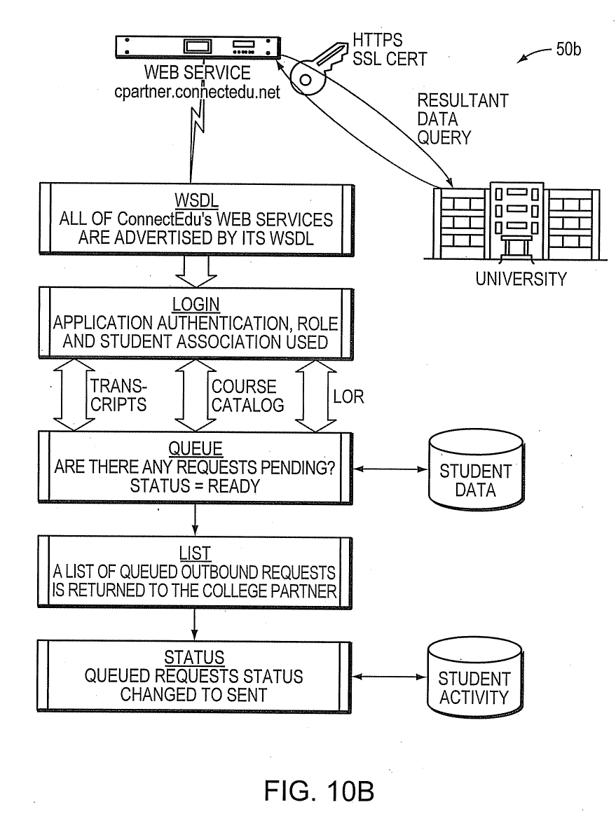

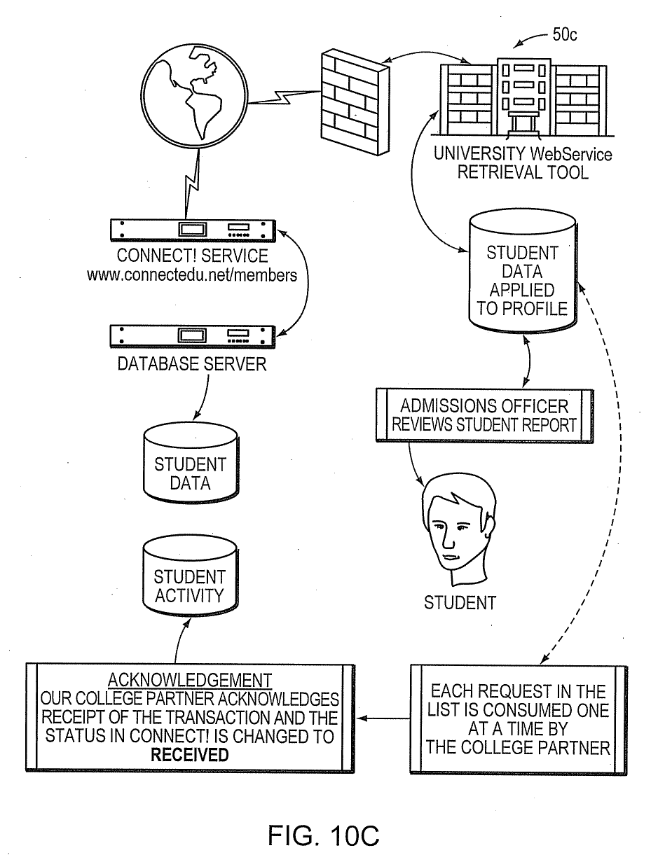

Although FIG. 1 discusses a general overview of a software and hardware based system 10 in the context of various communication channels and data exchanging entities, FIG. 6 illustrates how another exemplary system platform 20 interacts with its member communities: high schools, community colleges, and colleges. In addition, other specific workflow embodiments relevant to the exchange of transcript data and other student specific data are described in more detail with regard to FIGS. 8 and 10.

Colleges and universities require measurable and cost-effective methods of interacting with and attracting students as well as retaining them once they arrive on campus. Because today's college-bound student is largely unresponsive to direct mail and other traditional marketing efforts, college admission officers require systems and methods to help them identify and directly communicate with targeted students. FIG. 6 depicts an exemplary system 20 for enrollment management and for automating the college application process. The electronic transcript process outlined in FIG. 1 and discussed in more detail below can be integrated in the system shown in FIG. 6.

In one embodiment, the system 20 uses a client-server approach similar to that discussed above with respect to FIG. 1. The system facilitates enrollment analytics in the form of collecting sufficient pre- and post-application success information, which are useable by admissions professionals to admit the right students, i.e. students that will succeed at this institution. The use of the first GPA and second GPA approach discussed above and the benefits of an electronic course catalog help achieve this goal.

As shown in right side of FIG. 6, a group of applicant generating entities 22 is shown. Specifically, high schools, other cachement area schools, and community colleges are shown as sources of feeder applicants that enter the enrollment management system for ultimate placement in a four-year college or university. The students that are seeking admission, their parents, the guidance counselors, and the transfer advisors are all involved in locating the best-fit college. The techniques and systems discussed above in more detail relate to finding the best school for a particular student. In the left side of FIG. 6, a collection 24 of the colleges, universities and their associated admissions offices are shown as handling the reciprocal problem of finding the best applicants. As shown, the collection of academic intuitions 24 can use SIS and/or Customer Relationship Management Systems with accompanying databases to track and store applicant data for subsequent analysis. The report generating functionality discussed above can be implemented in these systems. Student Information Systems (SIS)/Customer Relationship Management (CRM) database can be used to track every interaction with a potential student or parent right through the lifecycle of those interactions from applicant to matriculating student. To the extent that information is exchanged between an academic institution, the system can relate school performance information with the admit/deny prospect information.

The automated data analysis and information disseminating system 25 that ties together the collection of academic institutions 24 and the group 22 of applicant generating entities also interacts with a user community. This user community can include all of those individuals, institutions, and entities that subscribe or otherwise have access to the data analysis and information disseminating system 25. An electronic course catalog can be integrated as a portal in this community. The system 25 is configured to integrate with a CRM system using a software data service or web service such as those described herein. The modeling and analysis software 26 and the system 25 can be used generate reports such as shown in FIGS. 5H and 5I.

In one embodiment, the data analysis system 25 includes one or more databases and data analysis modules adapted for storing, retrieving, comparing, and correlating data. As shown, the data analysis system 25 can process retention data 25a, college prospect applicant data and admission data 25b, and articulation agreement data 25c. The transcript processing, electronic course catalog, and admit, deny, hold report generation can be performed using this system 25.

The retention data can be in the form of OLAP cubes; however, other suitable data structures can be used as appropriate for any of the data described herein, without limitation. Retention data is a data asset that is built up over time that identifies profiles, criteria, and other parameters relating to prospects, (prospective applicants), and admits, (admitted candidates), and what constitutes a successful vs. unsuccessful applicant. Retention data focuses on students that do not transfer or drop out. For example, an applicant that goes on to graduate and does well academically once admitted, may be considered a successful candidate and serve as the basis for establishing an admission profile indicative of success. College prospect applicant data and admission data relates to the individual data associated with those that apply and those that are ultimately offered admission.

In one embodiment, the system 20 of FIG. 6 uses a web service API to support CRM/SIS integration with the institution to support enrollment management. The following table summarizes a programmatic web services method for downloading the data about prospective students/candidates for enrollment management. The left column is the title of a program, routine or software module used by the relevant embodiment, the right column is a summary of some its functionality.

| Method | Summary |
|---|---|
| Login | Validates credentials against the web service and generates |
| | a time-sensitive sessionkey. The sessionkey must be used |
| | within 30 minutes, or it will time out. |
| | Note: In one embodiment, there is no separate login method |
| | for downloading transcripts, letters of recommendation and |
| | candidate information for enrollment management. In one |
| | embodiment, the same login credentials are used, and the |
| | same session key could be used either for transcript or |
| | recommendation letter queries. |
| GetCandidates | Determines if there are any candidates that are interested in |
| | the institution (for example a 4 yr college or partner). |
| | The result is a list of all prospective candidates, which |
| | identify the candidate(student) and provide more |
| | information from the candidate's record appropriately: |
| | If the result is 0 (zero), then there are no candidates with |
| | information ready to download and the user can exit. |
| | If the result is greater than 0 (zero), then there are |
| | candidates with information ready to download. |
| | The result may be an XML output or in any other |
| | machine-readable format. |
| | It is possible to transmit criteria for filtering the result |
| | set for this web method. That is, in one embodiment, |
| | parameters can be included to filter the result set based on |
| | the requesting institution's requirement. |
| GetNewCandidates | Determines if there are any new candidates that are |
| | interested in the institution (for example a 4 yr college or partner). |
| | The result is a list of all new prospective candidates, which |
| | identify the candidate(student) and provide more |
| | information from the candidate's record appropriately: |
| | If the result is 0 (zero), then there are no candidates with |
| | information ready to download and the user can exit. |
| | The result may be an XML output or in any other |
| | machine-readable format. |
| | If the result is greater than 0 (zero), then there are |
| | candidates with information ready to download. |
| GetCandidate | Downloads the information of a particular candidate for |
| | purpose of enrollment marketing. |
| | The result may be an XML output or in any other machine- |
| | readable format. |
| AcknowledgeCandidates | Acknowledges receipt of information on prospective |
| | candidates. In one embodiment, this module serves only as |
| | a feedback mechanism for the user of the system to |
| | differentiate between data that was sent and possibly lost |
| | along the way and data that was sent and properly received. |
| | add an AcknowledgeCandidates call after a GetCandidates |
| | or GetNewCandidates call. |
| AcknowledgeCandidate | Acknowledges receipt of information on a prospective |
| | candidate. In one embodiment, this module serves only as a |
| | feedback mechanism for the user of the system to |
| | differentiate between data that was sent and possibly lost |
| | along the way and data that was sent and properly received. |
| | Add an AcknowledgeCandidate call after a GetCandidate |
| | calls. |
| TagCandidates | This method provides a way to tag multiple prospective |
| | candidates with an expression indicating the institution's |
| | interest level for each of the candidate. |
| | In one embodiment, this module serves only as a feedback |
| | mechanism for the user of the system as an indicator of how |
| | the institution sees the candidate's information prospect to |
| | provide more transparency to the candidate. |
| | This can serve as an effective feedback mechanism from the |
| | target host system to the Connect system to communicate |
| | the interest, result and phases of a candidate's information |
| | used from an enrollment management or any other |
| | prospecting by the target institution. |
| | Add an TagCandidates call after a AcknowledgeCandidates |
| | or AcknowledgeCandidate calls. |
| TagCandidate | This method provides a way to tag a prospective candidate |
| | with an expression indicating the institution's interest level |
| | in the candidate. |
| | In one embodiment, this module serves only as a feedback |
| | mechanism for the user of the system as an indicator of how |
| | the institution sees the candidate's information prospect to |
| | provide more transparency to the candidate. |
| | This can serve as an effective feedback mechanism from the |
| | target host system to the Connect system to communicate |
| | the interest, result and phases of a candidate's information |
| | used from an enrollment management or any other |
| | prospecting by the target institution. |
| | Add an TagCandidate call after a AcknowledgeCandidates |
| | or AcknowledgeCandidate calls. |

In contrast with the web service API to support CRM/SIS integration discussed above, an XML based approach can also be used by the system 20. An example of an enrollment management candidate information XML code portion follows. This code portion supports CRM/SIS integration with the institution to support enrollment management.

(The data points are not limited by the ones shown in this example)

```
<Prospect HasOptedln=“True”>
    <Assignments>
        <Person>
            <Name>
                <FirstName>Ed</FirstName>
                <LastName>Missions</LastName>
            </Name>
            <Occupation>Admissions Officer</Occupation>
        </Person>
    </Assignments>
    <ContactStatus>NotContacted</ContactStatus>
    <Person>
        <ConnectID>123456789</ConnectID>
        <Birth>
            <BirthDate>1989-09-25</BirthDate>
        </Birth>
        <Name>
            <FirstName>Jessica</FirstName>
            <LastName>Parentless</LastName>
        </Name>
        <ParentGuardianName/>
        <Contacts>
            <Address>
                <AddressLine>9 Allison Street</AddressLine>
                <City>Ann Arbor</City>
                <StateProvince>MI</StateProvince>
                <PostalCode>48105</PostalCode>
                <CountryCode>US</CountryCode>
                <AttentionLine/>
                    </Address>
        </Contacts>
        <Gender>
            <GenderCode>Female</GenderCode>
        </Gender>
    </Person>
    <Organization>
        <ATP>230086</ATP>
        <OrganizationName>Huron High School (Ann Arbor, MI)</OrganizationName>
        <Contacts>
            <Address>
                <AddressLine>2727 Fuller Road</AddressLine>
                <City>Ann Arbor</City>
                <StateProvince>MI</StateProvince>
                <PostalCode>48105</PostalCode>
                <CountryCode>US</CountryCode>
                <AttentionLine/>
            </Address>
            <Phone>
                <AreaCityCode>734</AreaCityCode>
                <PhoneNumber>9942041</PhoneNumber>
            </Phone>
            <Email>
                <EmailAddress>jparente@huredu.edu </EmailAddress>
            </Email>
            <URL>
                <URLAddress>http://www. huredu.edu </URLAddress>
            </URL>
        </Contacts>
    </Organization>
    <AcademicSummary>
        <GPA>
            <CreditHoursAttempted>70</CreditHoursAttempted>
            <CreditHoursEarned>70</CreditHoursEarned>
            <GradePointAverage>3.27</GradePointAverage>
            <GPARangeMaximum>4</GPARangeMaximum>
        </GPA>
        <ClassRank>4</ClassRank>
        <ClassSize>6</ClassSize>
        <StudentLevel>TwelfthGrade</StudentLevel>
        <GraduationYear>2008</GraduationYear>
    </AcademicSummary>
    <Tests>
        <TestCode>803</TestCode>
        <TestName>The College Board's Scholastic Aptitude Test (SAT I)</TestName>
        <TestDate>2007-01-27</TestDate>
        <Subtest>
            <SubtestCode>00010</SubtestCode>
            <SubtestName>Critical Reading</SubtestName>
            <TestScores>
                <ScoreValue>544</ScoreValue>
            </TestScores>
        </Subtest>
    </Tests>
    <Profile>
        <activities>
            <clubs>
                <club>
                    <name>sailing</name>
                    <lengthOfTime>1 year</lengthOfTime>
                    <clubPosition>Volunteer</clubPosition>
                    <desc/>
                </club>
            </clubs>
            <arts>
                <art>
                    <name>Theater</name>
                    <discipline>Theater</discipline>
                    <lengthOfTime>3 years</lengthOfTime>
                    <desc>I have starred in our School productions.</desc>
                </art>
            </arts>
            <sports>
                <sport>
                    <name>Badminton</name>
                    <lengthOfTime>1 year</lengthOfTime>
                    <captain>No</captain>
                    <sportLevel>Hobby</sportLevel>
                    <desc>i luv badminton</desc>
                </sport>
            </sports>
            <hobbies>
                <hobby>
                    <name>Bottle top collecting</name>
                    <lengthOfTime>5+ years</lengthOfTime>
                    <desc>I have the largest collection of bottle tops.</desc>
                </hobby>
            </hobbies>
            <others>
                <other>
                    <name>My Other</name>
                    <lengthOfTime>3 years</lengthOfTime>
                    <desc>Too secret to share !</desc>
                </other>
            </others>
            </activities>
            <awards>
                <award>
                    <name>Student of the Year</name>
                    <associatedActivity>My Other</associatedActivity>
                    <desc>It's a secret but I got the honor of it all !</desc>
                </award>
            </awards>
            <experiences>
                <jobs>
                    <job>
                        <companyName>ConnectEDU</companyName>
                        <position>Intern</position>
                        <lengthOfTime>2 years</lengthOfTime>
                        <desc>A very pleasant experience!</desc>
                    </job>
                </jobs>
                <volunteerExps>
                    <volunteerExp>
                        <name>Rosie's Kitchen</name>
                        <responsibilities>Line Cook</responsibilities>
                        <lengthOfTime>A month</lengthOfTime>
<desc>Worked as a short order cook as a volunteer. Feeding the homeless and the
hungry.</desc>
                    </volunteerExp>
                </volunteerExps>
                <summerExps>
                    <summerExp>
                        <name>Life Guard</name>
<desc>I am a volunteer Life guard in my home town.</desc>
                    </summerExp>
                </summerExps>
                <others>
                    <other>
                        <name>Other Experience</name>
                        <lengthOfTime>1 year</lengthOfTime>
                        <desc> trained in shoeing horses.</desc>
                    </other>
                </others>
            </experiences>
            <skills>
            <languages>
                <language>
                    <name>German</name>
                    <listeningLevel>Fluent</listeningLevel>
                    <readingLevel>Intermediate</readingLevel>
                    <speakingLevel>Beginner</speakingLevel>
                    <writingLevel>Beginner</writingLevel>
                </language>
            </languages>
            <others>
                <other>
                    <name>Bird calling</name>
                    <desc>I am a champion bird caller.</desc>
                </other>
            </others>
        </skills>
        <interests>
            <programs>
                <program>
                    <discipline>Engineering</discipline>
                <levelOfImportance>important</levelOfImportance>
                    <desc/>
                </program>
            </programs>
            <activities>
                <activity>
                    <name>Soccer</name>
                <levelOfImportance> important</levelOfImportance>
<desc>I plan to continue playing at the college varsity level.</desc>
                </activity>
            </activities>
            <sports>
                <sport>
                    <type>Archery</type>
            <levelOfImportance>Not too important</levelOfImportance>
                    <desc>because</desc>
                </sport>
            </sports>
        </interests>
        </Profile>
    </Prospect>
```

Having discussed some specific software embodiments suitable for use in the system 20, it is useful to consider other features and functionalities associated with the system. For example, the system can extract data from various agreements, such as articulation agreements. Articulation agreements are agreements between the community college and an academic institution (4-year) that define how courses are to be transferred if a prospective applicant wishes to transfer from the community college to a 4-year institution. Articulation agreement data is used to provide automated information to prospective applicants such that they are informed about how their courses will transfer when seeking admission to a 4-year institution. In one embodiment, the design of the electronic course catalog enables processing of articulation agreement data to help students pick the right courses. The system 20 can load course catalog information on behalf of both two year and four-year institutions, and allow each to maintain a neutral store of articulation agreement information that is browseable to community college students.

In one embodiment, some of this system 20 functionality is implemented using Modeling and Analysis Software 26 that can be available on an “on demand” basis to facilitate analysis, understanding, and refined targeting of applicants for the purpose of enrollment management.

As shown in FIG. 6, the goal is to create an efficient market from the perspective of an admission officer. Another feature of the system 20 is to provide electronic transcript handling and letter of recommendation handling. At present, these features are expensive to manage using a paper-based approach. The various embodiments disclosed herein further streamline and automate the document management associated with college enrollment management and the application process. The methods disclosed herein provide users with an eTranscript function for seamless completion of college applications and transfer of academic information in a secure, encrypted environment. Users receive logs of indicating the transmission time and receipt of their transcripts to ensure that information is not lost or misplaced during the electronic delivery process to admissions office. Admission offices benefit with the reduction in paper. The ability to have business rules in the system 20 for automatic GPA recalculation is another advantage.

One aspect of the invention uses historical data to inform an institution's admit, deny, or hold decision-making process of an admissions officer for an academic institution. Given a pool of data identifying those applicants that the academic institution has admitted, conclusions and correlations can be drawn based on how those applicants succeeded or failed at the institution. In one embodiment, the data analysis uses OLAP cubes to describe the attributes of a successful applicants such as where they come from, what are the key factors that make them successful to model an admissions profile. Transcript data and course catalog searching can help inform this process.

Once a student has decided to apply to a particular academic institution, they can use the new tools available to start the process. If an academic institution's admissions office has already been in contact with the student, and the student has given prior permission, the academic institution admissions officer will be able to view the entire student record, courses, grades, GPA, and scores on that student. These items in the student's online record in the system 20 can be marked draft for review only and the items supplied by the student and by the school will be clearly identified as such. In one embodiment, no transmission of transcript data occurs without the student and guidance counselor taking discreet actions and providing approval.

After indicating their desire that a transcript be sent to an academic institution, as part of the application process, a workflow starts which alerts the school guidance counselor/transfer advisor by email and provides them with several review/decision steps. The counselor reviews and approves the request, verifies the transcript contents and vouches for its accuracy. This workflow mimics the current activity that occurs at most schools and provides a useful check/balance against inaccuracy and impetuous behavior on the part of the student. Finally, ETD is sent as discussed and illustrated in FIGS. 1, 8 and 10.

The systems shown in FIGS. 1 and 2 represent the direct integration between high school and college student information systems that the web services implementations described herein provide. These systems collect data in accordance with the system privacy standards and delivers transcripts, letters of recommendation, and course catalogs directly from high school student information systems (SIS), into our college partners' student information systems, as well as document imaging and management systems. One aspect of the invention includes supplying an infrastructure to the higher education institution to use these services.

Data Delivery Overview

| Data | Available formats |
|---|---|
| Transcripts (from high schools and | EDI S-FTP |
| community colleges) | XML web services |
| Letters of recommendation | PDF S-FTP |
| (from high schools only) | XML web services |
| Course catalogs (from high | XML web services |
| schools only) | |

By taking this approach, the system removes the data entry, scanning, and management costs and frustrations of transferring paper document to post-secondary institutions. In addition, the system will assist its partners by reducing the customer service costs of providing delivery confirmation and audit to its constituent audiences (school staff, parents, students, and letter of recommendation writers).

In a typical implementation, a college partner will build a client to retrieve all available transcripts and letters of recommendation for import once a day. FIGS. 8 and 10 illustrate exemplary workflows for data delivery from different systems (10, 20, and/or 25) to a higher educational institutions SIS. Prior to considering FIGS. 8 and 10 in more detail below, it is useful to consider some simplified workflows that depict aspects of the transcript and letter of recommendation delivery process.

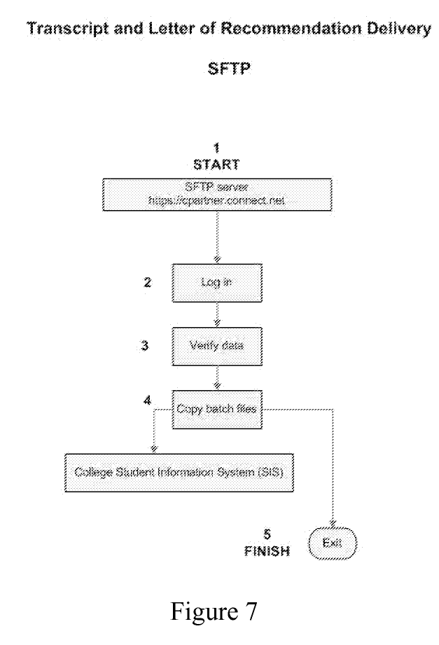

In one embodiment, as shown in FIG. 7, secure FTP (file transfer protocol) provides for secure retrieval of transcripts and letters of recommendation. To use this retrieval process, a user may be required to have a valid account with the service or system 10, 18, 25 and assigned access rights to the SFTP server directory. When documents are ready for delivery, they are collected in batch files (EDI format for transcripts, ZIP format for letters of recommendation, in one embodiment) and copied to the college's assigned directory on an SFTP server for collection. The directory may contain more than one batch file of each type. The following flowchart shown in FIG. 7 illustrates the transcript and letter of recommendation delivery workflow via SFTP.

Batches of files are used in order to signal package readiness for pickup and successful pickup. When a transcript or letter of recommendation document set is ready, it is assembled into a batch, and once picked up, is deleted by the remote S-FTP client and/or script, signaling that the remote process successfully retrieved and consumed the files.

Initially, the user connects to a secure file transfer protocol (SFTP) server, step 1. Once files have been uploaded to the SFTP, a college or other authorized party can download transcripts and letters of recommendation from the SFTP server. After a user connects to the server, the next step is to login, step 2. The login may require a user name and password associated with each university or college that has access to the SFTP server directory assigned to the particular university or college. The next step is to verify the data, step 3. Specifically, the user checks the directory to see if there are files present that are ready for delivery.

There are various different formats available for processing transcript and other student data. In one embodiment, transcripts are gathered in an .EDI file, with the following naming convention: CDU[date]-[token].edi where date is the date stamp and token is a random number used to ensure uniqueness. In another embodiment, letters of recommendation (in .PDF files) are gathered into a compressed, .ZIP file, with the following naming convention: CU[date]-[token]-[count].zip where date is the date stamp, token is a random number used to ensure uniqueness, and count is the number of letters of recommendation (in a .PDF or other suitable format) inside the file. However, other tokens, and naming conventions for verifying data are possible in different embodiments. Batch processing of files is also within the scope of the embodiments disclosed herein. Thus, in one embodiment, the next step, step 4, is to retrieve batch files. Specifically, in one embodiment, the user copies the batch file(s) to the student information system, and then deletes them from the SFTP server directory. When the user is finished with the file access or transfer the user exits the SFTP server, step 5.

As shown in FIG. 8A-8C, additional detail relating to an overall system 30a and subsystems 30b and 30c, respectively. The overall system 30a incorporates SFTP components as shown in FIG. 8A, which represents activities on the service provider side, such as the ConnectEdu data center, while FIG. 8A′ shows activities that occur on the institution side, according to one embodiment. FIG. 8B depicts a letter of recommendation creation subsystem 30b based on SFTP according to an embodiment of the invention. In turn, FIG. 8C depicts transcript creation for SFTP and course catalog web service using a subsystem 30c according to an embodiment of the invention.

One system for implementing the automated college application process, the financial aid application process, the electronic course catalog, and the electronic transcript transmission is the Connect service offered by ConnectEdu. As shown in FIGS. 8A and 8A′, information is exchanged between the Connect data center and a university data center. The embodiment shown in FIGS. 8A and 8A′, shows different activities which include course catalog upload, letter of recommendation processing, transcript processing, and an electronic course catalog access.

As part of the process of populating a database for an electronic course catalog, high school counselors upload all of the courses that their school offers for matching relative to transcript data as part of the college admissions process. The implementation show in FIG. 8A and FIG. 8B also facilitates an electronic letter of recommendation process by which an active student that is using the Connect service requests a teacher or guidance counselor to write a LOR. Also, from the student side of the workflow, FIG. 8A, an active student that is using the Connect system can apply to a college and their guidance counselor can electronically send or upload the active student's transcripts and LORs to the relevant college or university.

In contrast, as shown in FIG. 8A′, once the relevant college or university has received the transcript, or a batch of transcripts, the college admissions office can login to the Connect service, authenticate themselves, and access an electronic course catalog for the active student's high school. The electronic course catalog allows a user to search for a particular high school and matches course ID in transcripts to catalog entries. As discussed herein, this feature can also be integrated with a college's SIS system to perform automatic grade recalculations.

As shown in FIGS. 8A and 8A′, the Connect service is shown in electronic communication with a public network such as the internet to affect data exchanges with students and colleges. The Connect service can also be connected to a database server in one embodiment. In turn, as shown, the database server is adapted to access and update student data. Although the student data can be stored in various formats, in one embodiment the data is stored using an SQL database format. As a result, in one embodiment, when the data is accessed by an outside server, a SQL extraction is performed. The B2B engine, shown in FIGS. 8A-8C, supports secure access to application materials for college partners on behalf of students and their guidance counselors and reciprocal secure access for student in some embodiments.

The B2B engine can be used to initiate a batch process for letter of recommendation creation. In addition, the B2B engine can be use to start an electronic transcript application process. With respect to the electronic transcript application process flow, as shown in FIGS. 8A and 8C, once the process is initiated the next step is for the underlying software and/or hardware is to assemble the data for all “Ready” transcripts. At this time, the status of the unsent file is changed to Batch Ready and an identifier is also generated with the batch. Next, the transcript data's status is changes to “Batch Sent.” In this manner, the process of delivery is confirmed and status information is available to interested parties via the Connect application itself (e.g. “Your transcript has been sent to University X”). The transcript file is changed to a fixed width file. In one embodiment, an archive copy of the transcript files is created and stored with the archive files.

The active transcript data is transferred to a staging folder with a particular file extension. In one embodiment, the extension is of the form * .edi, the .edi extension indicates the use of the Electronic Data Interchange format, an industry standard file format. The role of the staging folder is to assemble files for pickup and delivery. The format of the transcript data can be such that the file naming protocol is associated with a particular recipient college or university. From the staging folder, the data is encrypted. The encryption can be performed using various encryption techniques know in the art. However, in one embodiment, a PGP public key approach is used and the PGP encrypted files are moved to a transcript pickup folder.

As shown, in FIG. 8A′, a college or university can pick up their files from this transcript folder. As a result, the database status is changed to reflect a “Batch Received Status.” As shown, the transcript pickup folder may be accessed via an IP restricted firewall using a secure file transfer protocol server. Specifically, a college can access this server through the internet to download the transcript data to their SIS system. In other embodiments, scripts can be used to automate the transcript transfer process such that the data is automatically directed to the college SIS in a secure manner.

The B2B engine initiates a similar process for the letter of recommendation (LOR) process as shown in FIGS. 8A and 8B. As shown, the engine starts the LOR creation batch runs. Creation of multiple letters of recommendation occurs electronically such that the letters route via email in one embodiment. These letters are then zipped to form one file. Next, the LOR zip file (or files) is (are) sent to a staging folder. A PGP process or other suitable encryption algorithm secures the files. A LOR pickup folder receives the encrypted files. From this folder, a college or university partner picks up their files and the database status change to “Batch Received Status.” As discussed above with regard to the transcript data, automating the LOR transfer process is possible using scripts such that the data automatically reaches the college SIS in a secure manner.

As shown, the college or university data center can access the pickup folders and the Connect service via a public network(s) such as the internet through a firewall-protected checkpoint. Typically, the university has its own SFTP client or a client provided by the Connect service. The university has access to the private keys necessary to decrypt the PGP encryption used for both the LOR files and transcript files. The data from both of these file types can be used by an Office Undergraduate Admissions (OUA), or other decision-making authority, to make admit, deny, or hold decisions. As discussed in more detail herein, the university or college data center can also include a client or other software necessary to implement or access an electronic course catalog to evaluate each applicant's transcript data.

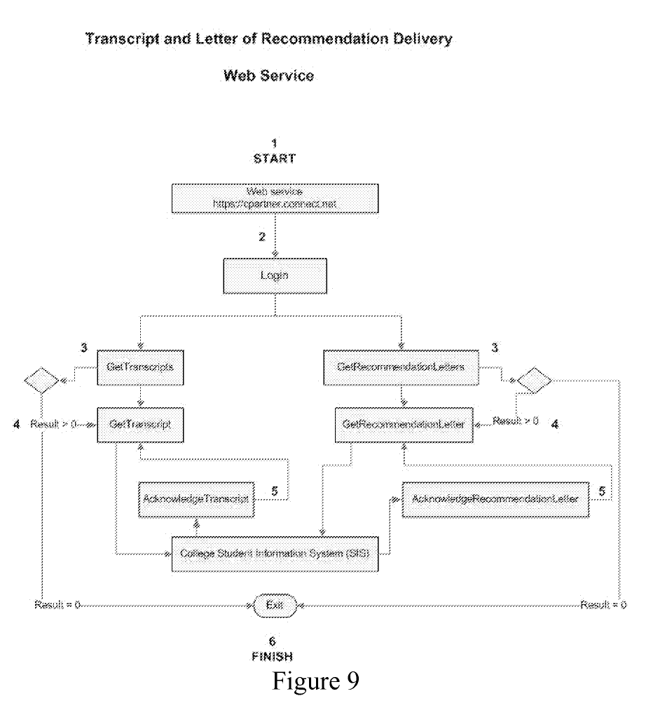

Although a secured FTP server is one option, as discussed above and shown in FIGS. 8A-8C, in another embodiment, as shown in FIG. 9, transcript and letter of recommendation delivery by a web service or any other software data service perform the relevant tasks. A programmatic web service manages and transmits transcripts and letters of recommendation. The user typically has a valid college partner account with a service, such as the Connect service, and a script to automatic each step in the workflow. The following flowchart illustrates an embodiment of the transcript and letter of recommendation delivery workflow via a web service.

As shown in the flow chart in FIG. 9, the first step for this exemplary process flow is to connect to the web service. For this particular flow chart, a college partner can download transcripts and letters of recommendation from a web service using a web interface. To connect to the web service as shown in step 1, the user starts his or her browser and goes to a particular internet address, such as https://cpartner.connectedu.net/catalog.

For security reasons, and to regulate the level of access available to different users, the web service may require a login, step 2. Typically, the login requires a user name and password to access the service. A login request, Login(username, password), validates a college partner's credentials against the web service and generates a time-sensitive sessionkey in one embodiment of the invention. In one embodiment, the sessionkey must be used within a preset period, such as 5, 10, 15, 30, or 45 minutes, or it will time out. However, other preset periods are possible. In one embodiment, the same login credentials are used, and the same session key could be used either for transcript or recommendation letter queries. However, different logins can have different levels of access and different session keys can be used in various embodiments.

Depending on the files of interest to a particular user, the next step, step 3, is to obtain transcript and/or letter of recommendation data. As part of this process, it is useful to verify that LOR or transcript data is available. A verification request, GetTranscripts(sessionkey) or GetRecommendationLetters(sessionkey), determines if there are any documents ready for transmission.

The result of this request is a list of document IDs, which identify the school and the student. If result is a list of O (zero) entries, there are no transcripts or letters of recommendation to download, and the script exits (Step 6). If the result is a list with one or more entries, then there are transcripts or letters of recommendation available to download. The script stores the document IDs and continues to request data (Step 4). A data request, GetTranscript(sessionkey, transcript_id) or GetRecommendationLetter(sessionkey, recommendation_letter_id), retrieves the next available document and downloads it to the college's student information system. In one embodiment, the script sends an acknowledgement (Step 5) before sending the next data request. This can be achieved by using an acknowledge data receipt. Specifically, in one embodiment, an acknowledgement, AcknowledgeTranscript(sessionkey, transcript_id) or AcknowledgeRecommendationLetter(sessionkey, recommendation_letter_id), confirms that the document has been received. If there are document IDs remaining in the list, the data request (Step 4) is repeated. If there are no document IDs remaining in the list, the script can exit (Step 6). When the user is finished with the file access or transfer, the user exits and the script closes the browser and exits the web service.

In FIGS. 10A-10C, additional detail relating to an overall system 50a and subsystems 50b and 50c, respectively, suitable for implementing aspects of the invention is shown. Specifically, FIG. 10A shows a system that incorporates a web services implementation. FIG. 10B shows a subsystem 50b that depicts an exemplary transcript, letter of recommendation, and course catalog web service structure according to an embodiment of the invention. In turn, FIG. 10C, shows a subsystem 50c that depicts an exemplary student data retrieval and acknowledgement structure according to an embodiment of the invention.

One system for implementing the automated college application process, the financial aid application process, the electronic course catalog, and the electronic transcript transmission is the Connect service. As shown in FIGS. 10A-10C, information is exchanged between the Connect data center and a university data center.

As shown in FIGS. 10A-10C, the Connect service is shown in electrical communication with a public network such as the internet to affect data exchanges with student and colleges. The Connect services can also communicate with a web services platform and an automated web service data retrieval tool through a public network. In addition, the Connect services can also be connected to a database server in one embodiment. As shown, the database server is adapted to access and update student data. Various interactions with the Connect services can act as data triggers, as shown in FIG. 10A, which result in database information being updated or transmitted. As used herein, the term data trigger means a software signal that indicates that an action should be taken. Examples of data triggers include approval for transcripts, letters of recommendation generation, and course catalog updates. In response to a data trigger, both the student data and/or the Connect service may be accessed.

Because of a data trigger or other event, in one embodiment, the web services are described and made available using a Web Services Description Language (WSDL) implemented by the Connect college partner system. Specifically, the WSDL alerts colleges or universities using the Connect system that certain types of transcripts and letters of recommendation are available to them. In one embodiment, the web services are accessed by a login routine.

Typically, the college or university partners are accessing the web services to obtain transcripts, letter of recommendations, course catalogs or other student specific information as shown in FIGS. 10A-10C. As multiple requests may be received for multiple educational institutions, the requests for information and data can be arranged in a queue. The system is design to check the queue to determine if there are any requests pending. If there are no requests pending the system status is flagged as “ready.”

Once the college partner has sent a request the system returns a list of queued outbound requests to the College Partner, such a college, university, lender, scholarship provider, or other partnered with entity. At this point, the queued requests status is changed to “sent.” Once the request is sent, the system updates information relating to student activity. Each transaction is acknowledged by College Partner and the status changed to “received.” Each request in the list is consumed one at a time by the college partner. The college partner uses the automated web service data retrieval tool to request transcripts and letters of recommendation individually or by status (e.g. request all new transcripts”). At the admissions office, or through the Connect service, student data is applied to an applicant's profile to help the admission's officers make admit, deny, hold decisions. Specifically, after updating the profile, an admissions officer student report can be generated.

The systems described herein comply with (FERPA) and related federal and state laws by acting as an agent of the school. With respect to the laws on privacy and related disclosure concerns, the system requires an explicit opt-in decision on the part of the student prior to making a transcript or letter of recommendation electronically available. In addition, in most cases, the guidance counselor also participates in the request workflow, further assuring the legitimacy and accuracy of the request and associated materials.

The system supports a high school transcript XML format and college transcript XML format on behalf of community colleges who wish to transfer students to a senior institution.

### Security Planning

To ensure that identifiable student information is shared in compliance with applicable security standards. In one embodiment, the systems (10, 20, 30, 50) reviews security implementation and exchange details to ensure the secure exchange of student data.

In one embodiment, depending on the implementation, the system will exchange various types of information. The system will provide an administrator account (user name and password) with rights to download student data from the web service. The college will provide a list of IP addresses for secure systems where student data may reside. Either the system or the college will provide SSH keys for use with S-FTP only. In one embodiment, implementation details depend on the data transfer implementation. The web services implementation uses SSL for security and a valid set of credentials. Normal web ports are used, so no special security approach is needed. S-FTP implementation usually requires: (1) allowing Secure FTP from a specific range of IP addresses, and (2) sharing of an SSH key. The college partner may choose to use their own SSH key pair.

Transcript collection and integration is part of one system platform and implementation process embodiment. When a high school or community college becomes a customer, its demographic, course, and transcript information can be loaded automatically. A school typically provides as student verification file (student and parent information for registration) and a transcript file (courses, grades, and test scores).

This data can be provided to a web services implementation of the application 18 by using an extract filter for the high school's student information system to move student registration and transcript data out of the SIS in the form needed to be loaded into on one of the systems 10, 20, 30 and/or 50. In one embodiment, the student information system at the high school or community college is the database master in this process, and the system grade repository derives from it. If an error is present in the school's student information system, it will also be present in the system and must be fixed in the school system in order to be migrated to the system database.

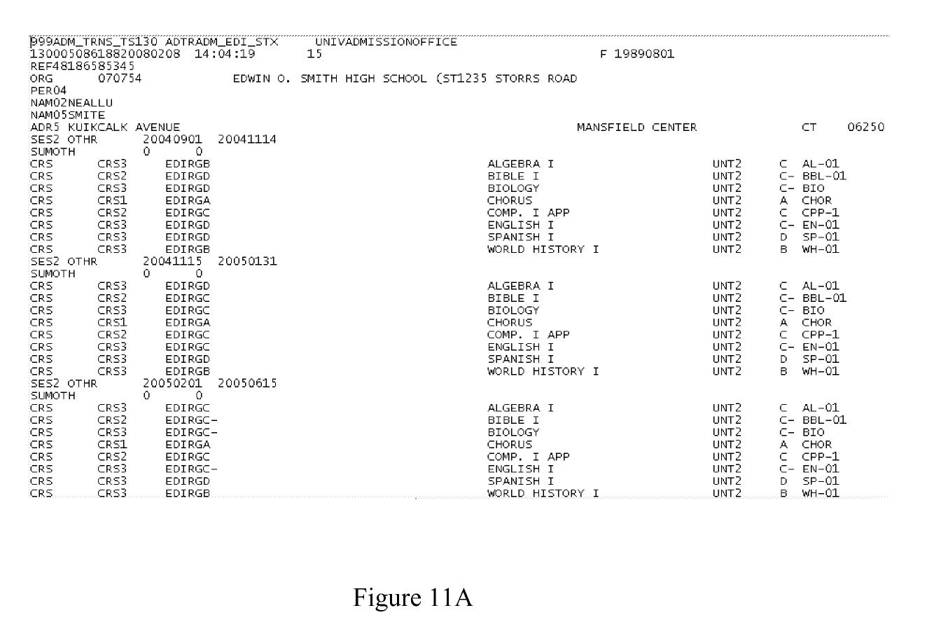

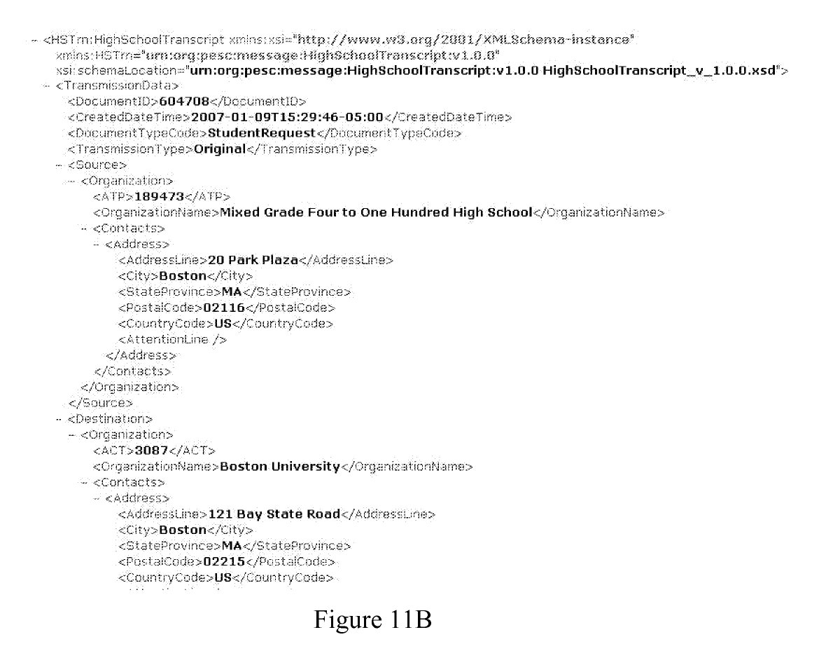

The system can provide an EDI export of the transcript requests, which is intended for import into a management system such as for example, PeopleSoft. One method for retrieving that EDI is to do so via secure FTP on a regular schedule (for instance, once per day). The EDI file could also potentially be sent over other channels, such as a web service. An example of an EDI transcript is shown in FIG. 11A.

### Transcript Requests

Once a student has decided to apply to a college, he or she can use the tools available in the system or application (10, 18, 20, 25, 30, and/or 50) to start the process. If the college partner admissions staff has already been in contact with the student and the student has given prior permission, the admissions officer will be able to view courses, grades, GPA, and scores for that student. No transmission of transcript data occurs unless the student and/or guidance counselor take discrete actions.

In one embodiment, the student has the option of supplying his or her date of birth when making the transcript request. The college can use this information to match the transcript request to the student's record and, possibly, speed the transcript-integration process. The student's date of birth is stored, in an encrypted format, only in a transcript request. It is unencrypted when it is sent. However, other registration and verification approaches can be used.

When a student asks to send a transcript to a college as part of the application process, the guidance counselor/transfer advisor first reviews and then approves the delivery of the transcript. Once approved, the transcript is immediately available to the assigned admission office in the system portal and is queued and ready for movement into the target student information system.

In one embodiment, a student may request multiple transcripts throughout the process, in order to comply with early decision, regular decision, seventh semester, and final transcript delivery requirements. Each transcript is made available as a discrete XML archive or other format.

### Download Transcripts

Each time a transcript is submitted for review and transmission to a college partner, an archive of that transcript can be created using the course, grade, and score information that was available and current at the time of submission. Subsequent requests to send a transcript will create a new archive of the transcript data that is both stored and transmitted based on the then-current information. In this way, an auditable trail of transcript information is kept in the same manner as is customary with paper-based filing systems and current practices. On example that illustrates a sample transcript file in XML format is shown in FIG. 11B. A further example that illustrates a sample transcript file in pdf format is shown in FIG. 11C.

The following table summarizes a programmatic web services method for downloading transcripts according to one embodiment. The left column is the title of a program, routine or software module used by the relevant embodiment, the right column is a summary of some its functionality.

Transcript methods

| Method | Summary |
|---|---|
| Login | Validates credentials against the web service and generates a |
| | time-sensitive sessionkey. The sessionkey must be used within |
| | 30 minutes, or it will time out. |
| | In one embodiment, there is no separate login method for |
| | downloading transcripts and letters of recommendation. The |
| | same login credentials are used, and the same session key could |
| | be used either for transcript or recommendation letter queries. |
| GetTranscripts | Determines if there are any transcripts awaiting transmission |
| | and identifies any available transcripts by transcript ID. (A |
| | transcript is available if it has not already been downloaded.) |
| | The result is a list of transcript IDs, which identify the school |
| | and the student: |
| | If the result is 0 (zero), then there are no transcripts ready to |
| | download and the user can exit. |
| | If the result is greater than 0 (zero), then there are |
| | transcripts ready to download. |
| GetTranscript | Retrieves the next available transcript in PESC-compliant XML |
| | format and downloads it to the college's information system. |
| | Repeat this command until all available transcripts are |
| | downloaded. |
| AcknowledgeTranscript | This module acknowledges receipt of a transcript. In one |
| | embodiment, this module serves only as a feedback mechanism |
| | for the user of the system to differentiate between data that was |
| | sent and possibly lost along the way and data that was sent and |
| | properly received. |
| | Be sure to add an AcknowledgeTranscript call after each |
| | transcript is received through a GetTranscript call. |

### Letters of Recommendation

The system supports automated request, collection, storage, and transmission of letters of recommendation. Letters of recommendation are created via a form within a embodiment and are made available as XML documents, uniquely identified by student. In one embodiment, all available letters of recommendation for the student made part of the same XML document when requested.

Letters of recommendation may be sent to the college as a PDF file or as XML Meta data. In each case, the data can be either (1) packaged and placed on a secure FTP site for pickup, or (2) queried via a web service. The following example illustrates a sample letter of recommendation (PDF).

Sample letter of recommendation in PDF format

```
Recommendation Letter for Rachel Ames
Student Information
  STUDENT: Rachel Ames
  CONNECT ID: rames
  GENDER: F
  DOB: Unknown
  SS#: Unknown
  ADDRESS: 22 Quincy Ave:
  CITY/ST/ZIP: Allston, MA 02134 US
Recommender Information
  NAME: Tim Jones
  OCCUPATION: Soccer Coach
  EMPLOYER: Public High School
  SCHOOL ADDRESS: 20 Oak St.
  CITY/ST/ZIP: Boston/MA/02116
  PHONE: (781) 555-1212
  EMAIL: as@ghs.edu
Student Character
  How long have you known this student?
  I've known Rachel for over 4 years, throughout
  her entire high school education.
```

### Letter of Recommendation Requests

When a student uses the Letter of Recommendation (LOR) request tool to make requests of teachers and other valid recommenders, the LOR request tool sends all pertinent information to the recommender via e-mail, and includes the student's current resume and any other information that the student feels will help the recommender write the letter of recommendation appropriately.

After the letter of recommendation writer completes the LOR form and uploads text to the system using a temporary login, the student, parent, guidance counselor/transfer advisor, and admissions officer are able to identify that the letter of recommendation is completed.

If a review is required, the guidance counselor can accept or reject the letter of recommendation. When the letter of recommendation is accepted and (optionally) reviewed, the college partner/admissions officer roles at the target school have immediate secure access to the information by logging into the system and clicking an individual in their list of student prospects/candidates.

### Download Letters of Recommendation

In one embodiment, methods for downloading letters of recommendation have been designed to work parallel to the transcript download, with one noticeable difference. Specifically, there is no PESC standard for recommendation letters and thus no compliance to such a standard is required. The following table summarizes the programmatic web services methods for downloading letters of recommendation. The left column is the title of a program, routine or software module used by the relevant embodiment, the right column is a summary of some its functionality.

Letter of recommendation methods

| Method | Summary |
|---|---|
| Login | Validates credentials against the web |
| | service and generates a time-sensitive |
| | sessionkey. The sessionkey must be used |
| | within 30 minutes, or it will time out. |
| | Note: In one embodiment, there is no |
| | separate login method for downloading |
| | transcripts and letters of recommendation. |
| | In one embodiment, the same login |
| | credentials are used, and the same session |
| | key could be used either for transcript or |
| | recommendation letter queries. |
| GetRecommendationLetters | Determines if there are any letters of |
| | recommendation awaiting transmission |
| | and identifies any available letters of |
| | recommendation by transcript ID. |
| | The result is a list of recommendation |
| | letter IDs, which identify the school and |
| | the student: |
| | If the result is 0 (zero), then there are |
| | no letters of recommendation ready to |
| | download and the user can exit. |
| | If the result is greater than 0 (zero), |
| | then there are letters of recommendation |
| | ready to download. |
| GetRecommendationLetter | Retrieves all letters of recommendation |
| | available for the student in XML format |
| | and downloads them to the college's |
| | information system. Repeat this |
| | command until all available letters of |
| | recommendation are downloaded. |
| Acknowledge- | This module acknowledges receipt of |
| RecommendationLetter | letters of recommendation. In one |
| | embodiment, this module serves only as a |
| | feedback mechanism for the user of the |
| | system to differentiate between data that |
| | was sent and possibly lost along the way |
| | and data that was sent and properly |
| | received. |
| | add an |
| | AcknowledgeRecommendationLetter call |
| | after a GetRecommendationLetter call. |

### Financing Subsystem

### Finance Manager Overview

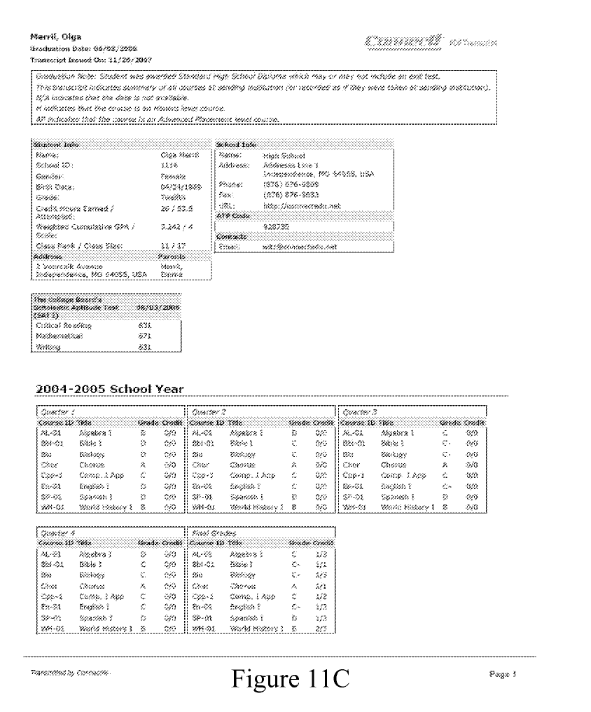

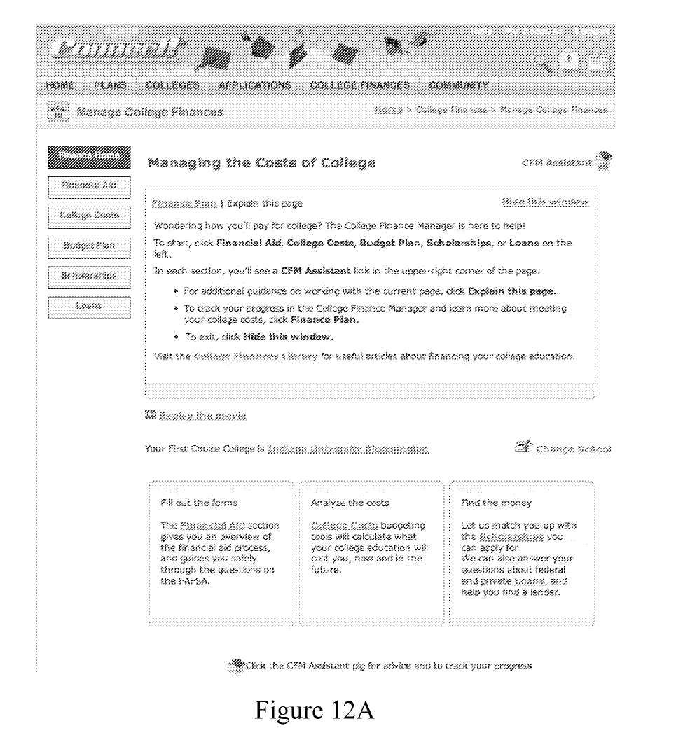

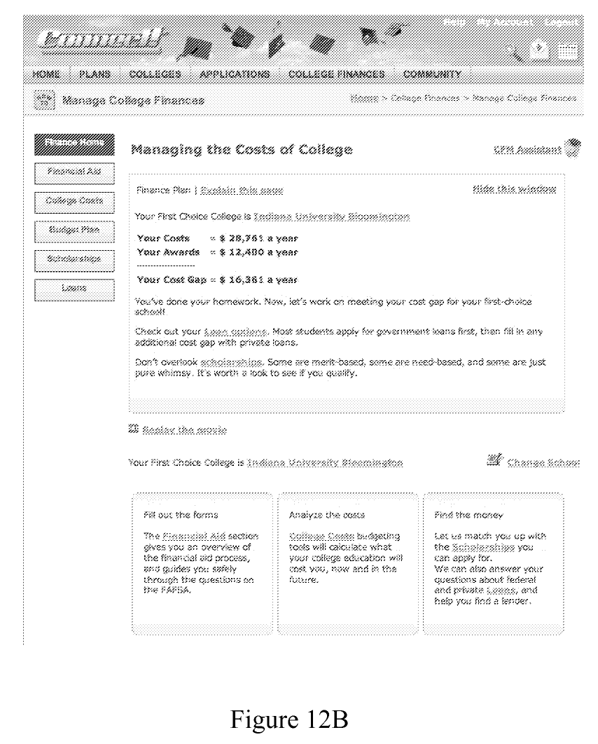

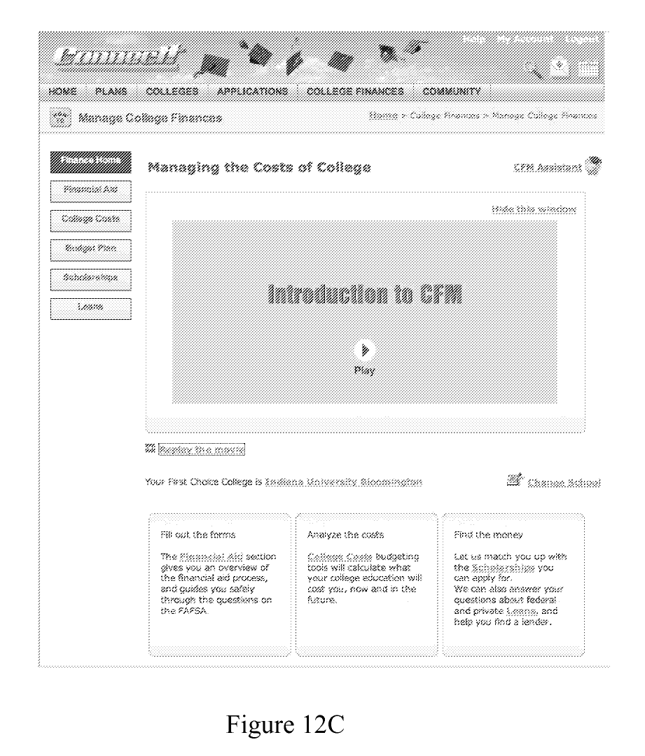

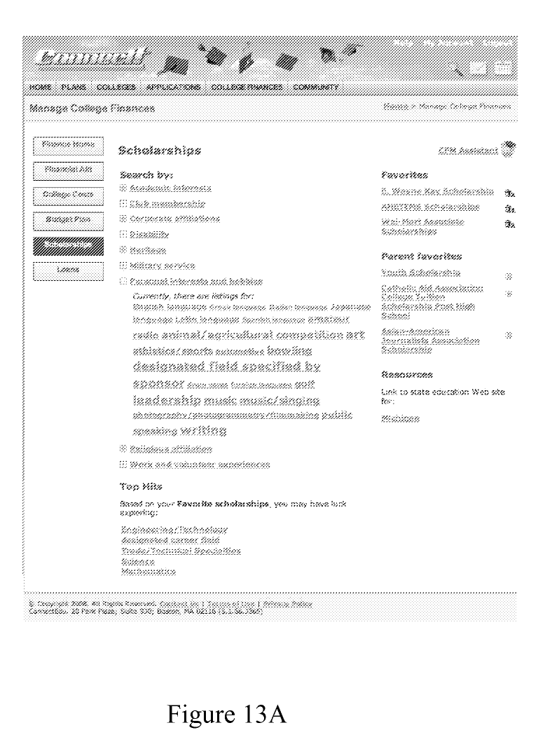

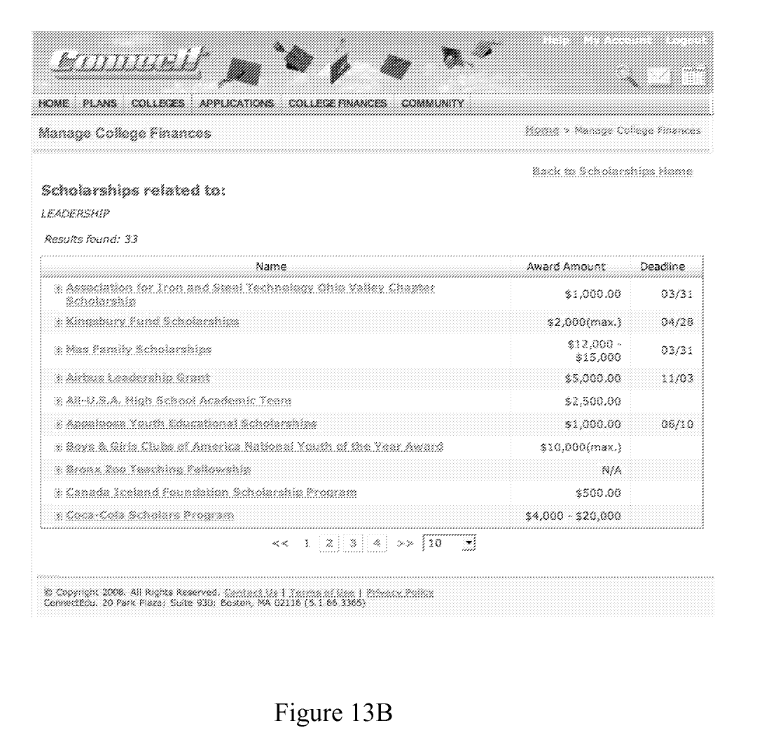

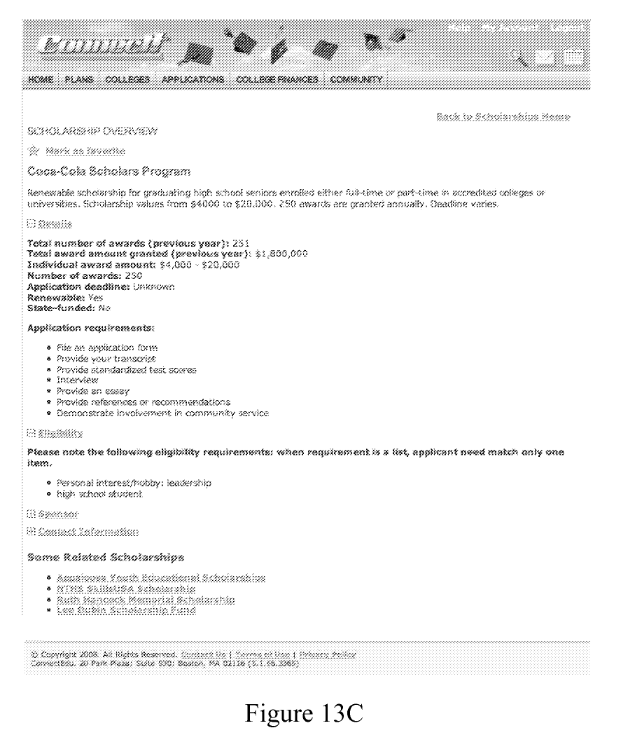

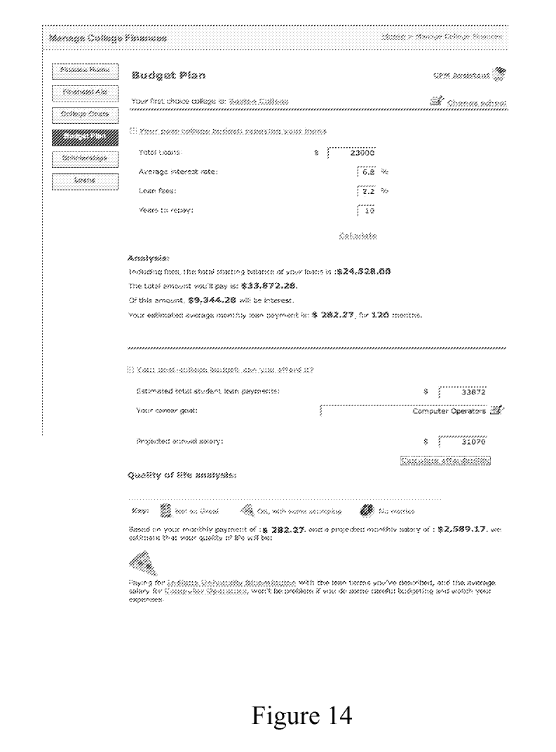

One aspect of the invention relates to college financing systems and methods. Various interfaces and details relating to the finance manager are shown in FIGS. 12A-12C; FIG. 13A-13C; and FIG. 14. However, these aspects and features of the invention may be extended to any finance management process between two institutions (educational or partners). The embodiments disclosed herein serve high school students and parents as well as community college students who wish to apply or transfer to four-year colleges and universities. The majority of these students need assistance with paying for college. However, once they apply many will qualify for some type of financial aid assistance. Similarly, many of these students will also need loan assistance to complete a four-year degree.

The financial aid process is complex, and there is little or no in-person support for students or their families from the Department of Education, colleges, guidance counselors, or others in the going-to-college process. The student loan process typically works in parallel with the financial aid process, which typically functions for one academic year at a time and must be repeated annually.

A Finance Manager, for an educational institution described herein incorporates a workflow for a student and/or parent to obtain assistance with any or all parts of the financial aid process with a specific, qualified institution in mind. In the embodiment, wherein the relevant institution is a college, the term College Finance Manager or CFM is used herein. However, this term College Finance Manger is intended to encompass any educational institution. At the end of the financial aid process, the student can understand the gap in his or her ability to pay for a specific college and find either standard or alternative funding options to make up that gap.

The CFM serves as one “place” or portal, similar to the application 18 and other interfaces described herein, that provides interactive and text-based content, assistance, tools, and connections to get through the aid, scholarship, and student loan process smoothly. Typically, the CFM is implemented as a web services application with a graphic user interface. The College Finance Manager is an interface that serves as an aggregator for all of the steps involved in the financial aid process. The CFM allows one financial aid interview to be conducted such that information about the applicant and the applicant's answers to certain initial question tailor the interview process such that irrelevant questions are not posed. This keeps the process more manageable and prevents information overload.

In response to the answers to the interview, the federal financial aid form, the individual financial aid forms for each college being applied to, Pell grants, and other financial aid forms and scholarship applications are populated. Thus, by performing one efficient interview, multiple applications are completed in a substantially paperless process. The finalized electronic aid forms can be routed by the application 18 to various institutions and offices using secure communication channels.

As the CFM is designed to be a single aggregator for the financial process, the applicant will receive electronic notices of aid awards and the relevant timing for responding on a per school basis. Thus, in one embodiment, after completing the interview, the student may receive multiple notices from different schools arranged in a table that show the awards amounts given. The federal monies awarded can also be displayed in one central location as well as the shortfall amount for each school. The shortfall amount can be met using a private loan application process which is also available through the CFM interface. Scholarship awards can also be displayed via the CFM interface.

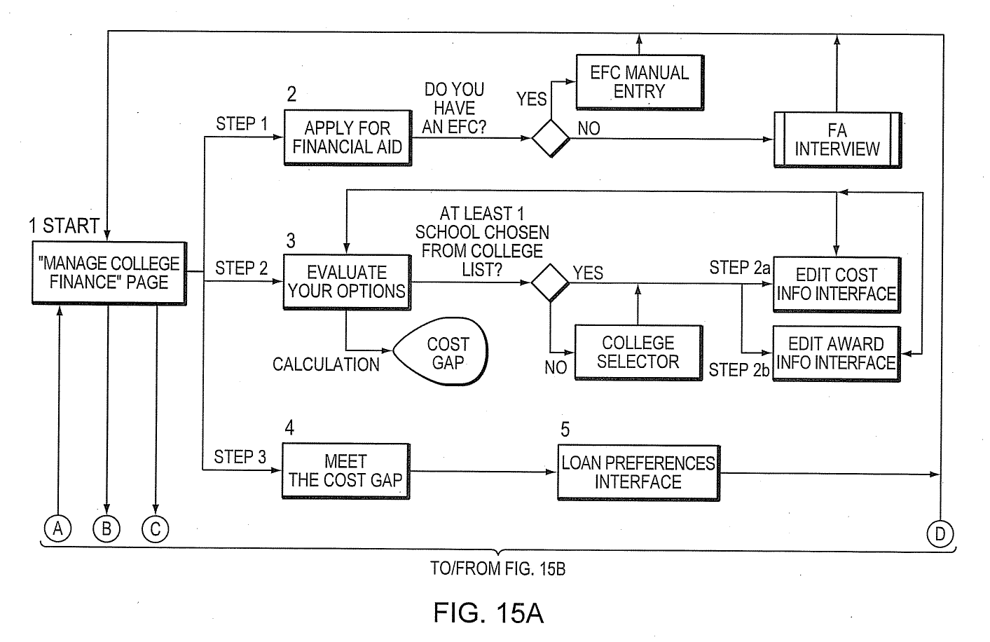

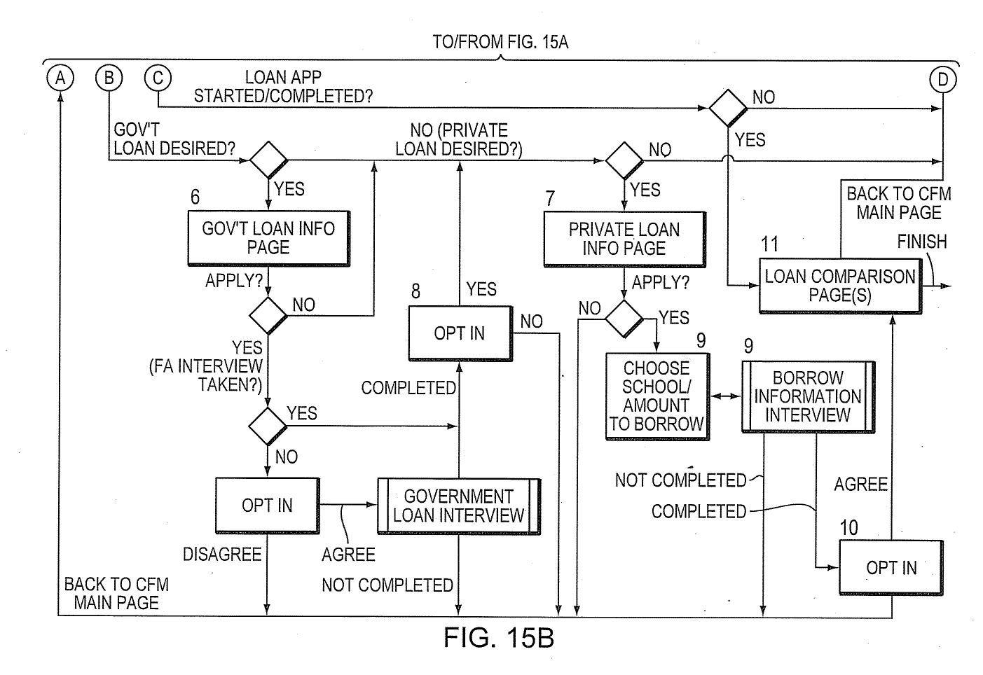

Prior to considering the detailed work flow relating to the financial process flow in FIG. 15, it useful to consider some high level features and interfaces as depicted in FIGS. 12A-12C; FIG. 13A-13C; and FIG. 14.

FIG. 12A is an interface indicating a finance manager assistant available to parents and students to manage financial planning for transition to college or any other opportunity. FIG. 12B is an interface wherein an automated financial assistant explains the finance plan to parents and students for transition to college or any other opportunity. In turn, FIG. 12C is an interface with the automated financial assistant presenting informational and educational multimedia content to help parents and students within the context of the finance manager.

The financial services features of the present invention extend to loans as well as to the scholarship application process. In particular, FIGS. 13A-13C relate to certain scholarship specific interface pages. FIG. 13A is an interface indicating scholarships available to students for transition to college or any other opportunity. FIG. 13B is an interface indicating scholarships available to students for transition to college or any other opportunity within a particular context. Finally, FIG. 13C is an interface indicating a scholarship overview available to students for transition to college or any other opportunity. Thus, the interfaces depicted relevant to scholarship and the other application features recited herein can be used to automate the scholarship application process. FIG. 14 is an interface indicating a budget plan available to students and parents to help with the financial management for transition to a college or any other opportunity.

Additional features of this financial aid aspect of the invention include are also described herein. Supporting students and parents through the entire annual financial aid process (November through June of senior year for a high school student) is one such feature. This support may be done with deploying unique software based techniques that use various multimedia-based tools and techniques to help members like students, parents, etc. with the financial aid process to transition to the next step. Although, the next step is not limited to college, graduate school or any other opportunity.

The interface associated with financial planning also provides access to one or more government and private (also known as alternative) student loan processes. This portion of the system also helps users comply with all applicable federal and state laws, and with the regulatory compliance initiatives managed by different financial partners. In addition, the financial interface provides valid loan applications as self-contained data files to private and government loan partners. These data files can be used to originate loans.

### Finance Manager Workflow

The finance manager workflow provided below illustrates exemplary steps for the student or parent who is interested in learning more about financial aid options. In one embodiment, each step is completed before moving on to the next. However, the student is not required to identify a school or loan amount before starting the loan application. Each numbered section following the workflow provides further information about each step identified in FIG. 15.

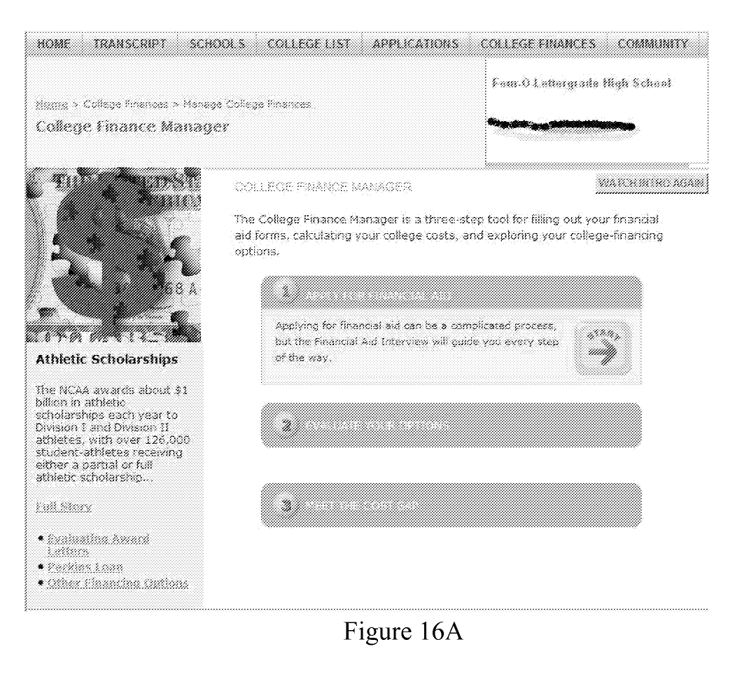

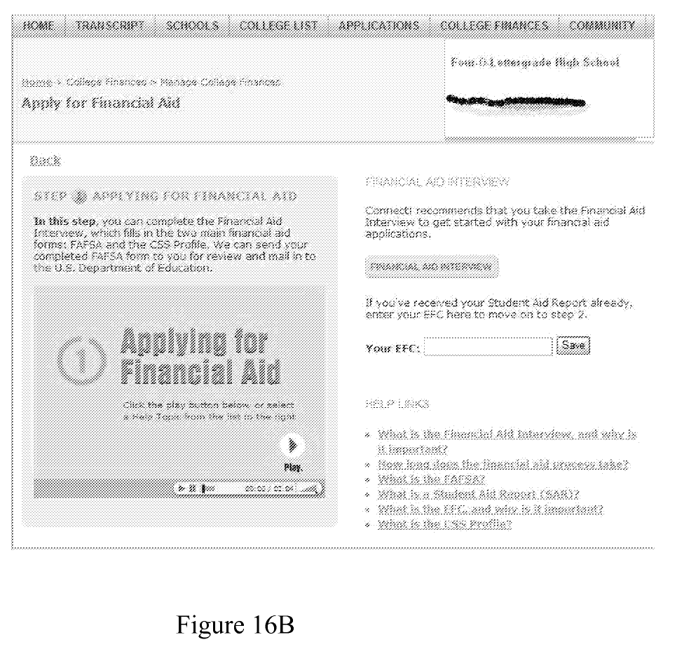

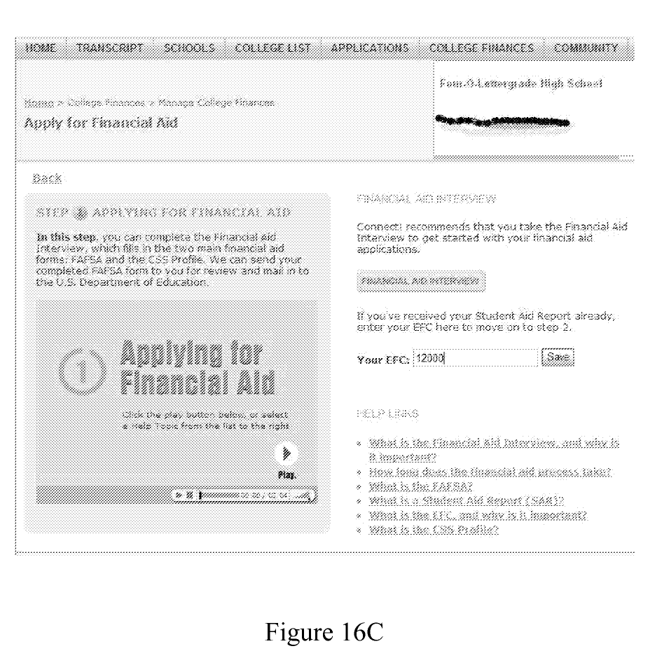

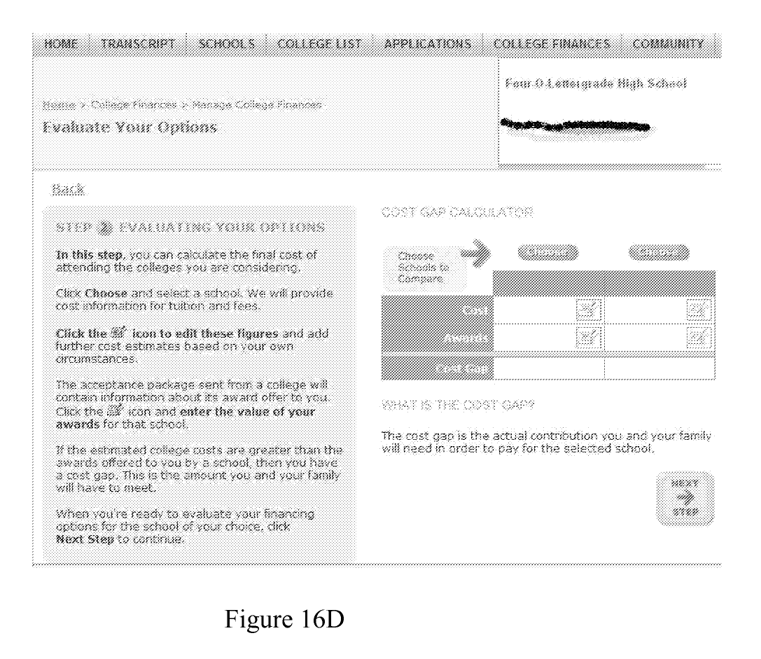

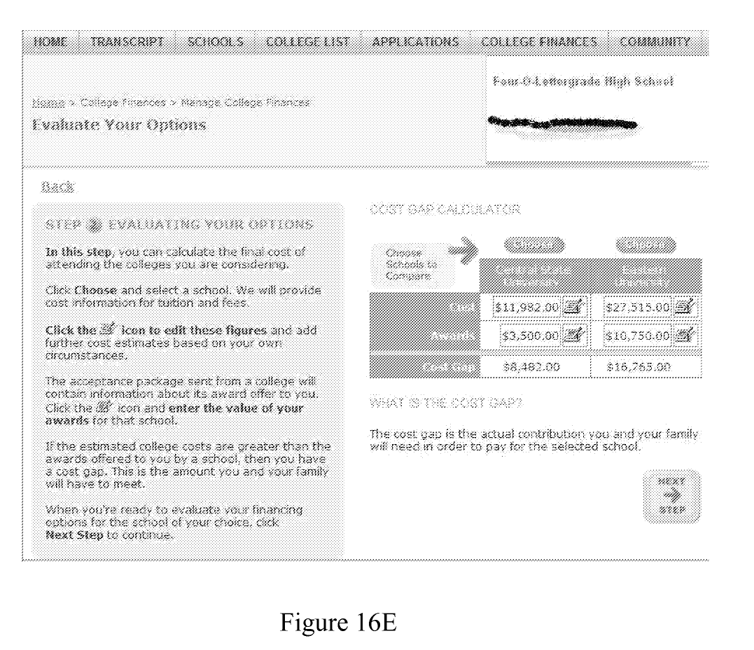

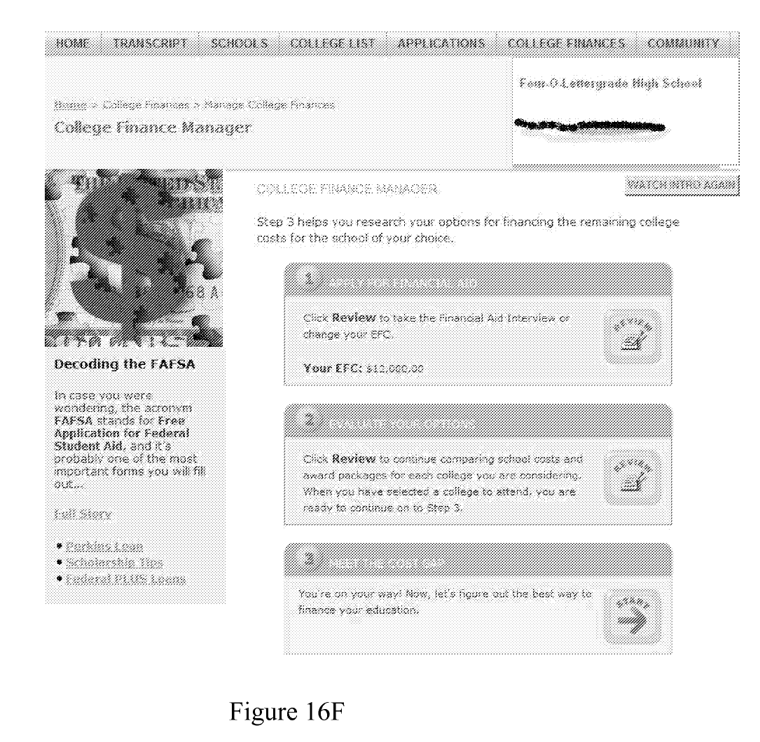

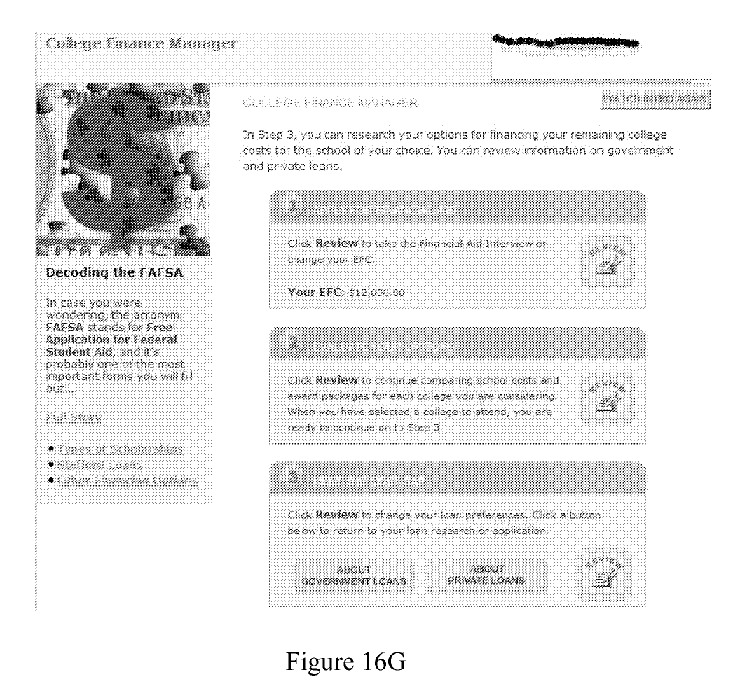

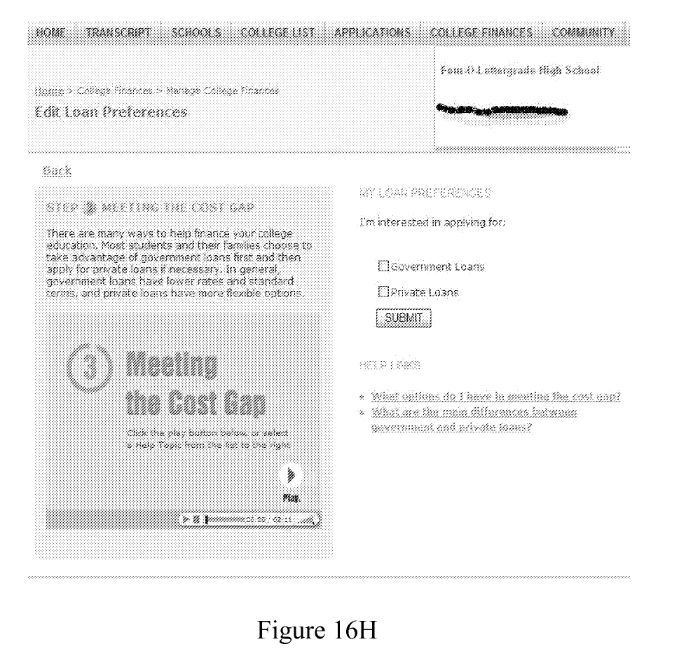

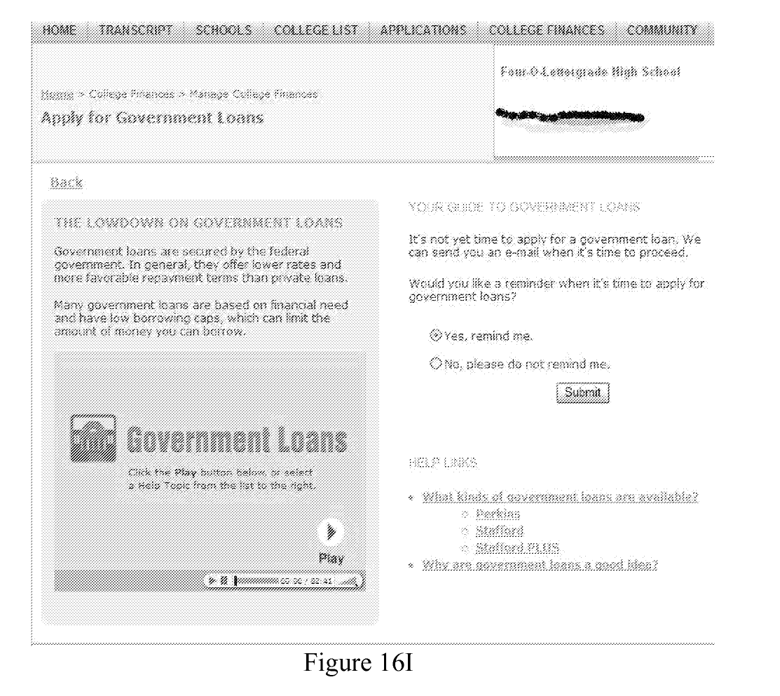

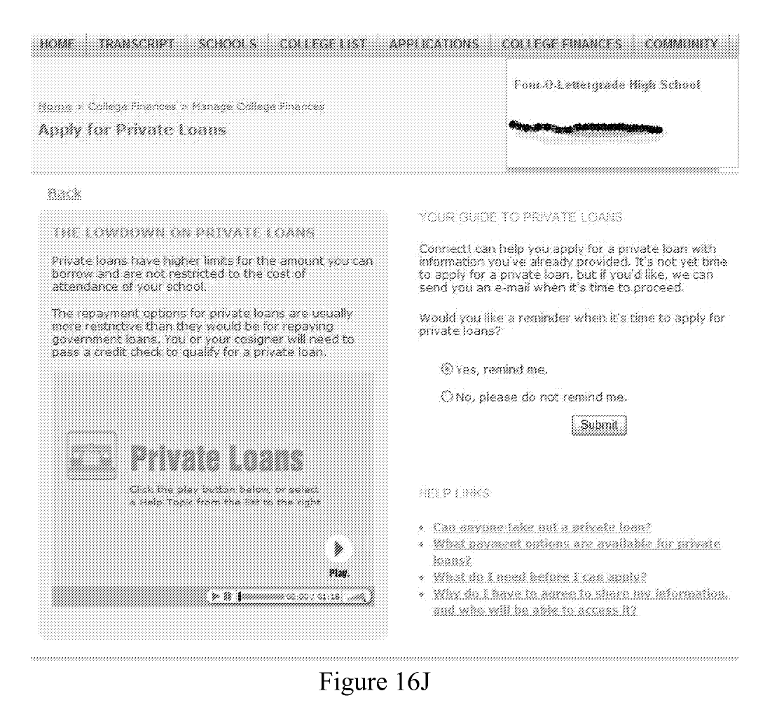

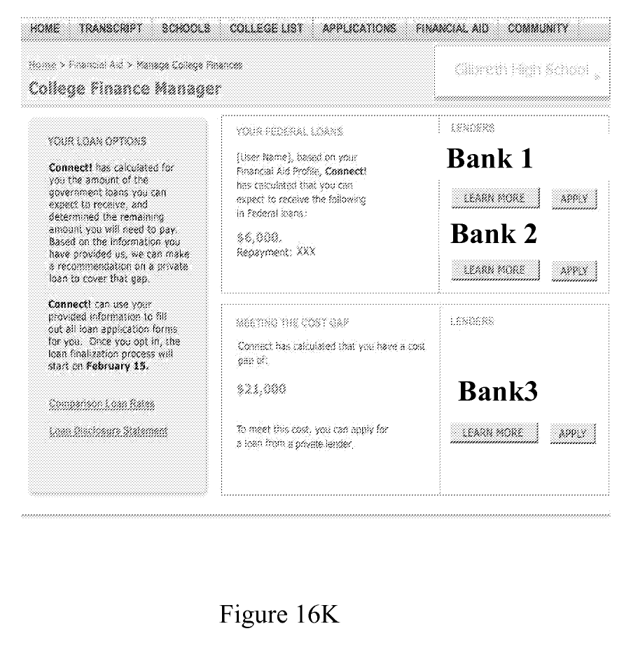

With respect to FIG. 15, starting the Manage College Finances process is the first step (Step 1). The different steps of the workflow are then considered in order. Exemplary web interfaces are also depicted with respect to FIGS. 16A-16K that correspond to embodiments of some of the steps of the workflow of FIG. 15 or the other aspects of the invention discussed above.

Returning to the first step in the workflow, in one web services embodiment suitable for integration with the application 18, 25 and systems 10, 20, 30, 50 a College Finance Manager is high level interface that links to other interfaces relating to specific parts of the financial services offered by different embodiments of the invention. As shown in FIG. 16A, on the College Finances menu, the College Finance Manager is available to the user with three tools relating to applying for financial aid, evaluating your options, and meeting the gap in costs. Typically, the Manage College Finances page, and the Home page for College Finance Manager, is available to Parents and Students only. In one embodiment, the parent or student user cannot continue to a step until the previous step has been completed. Once a step is completed, the user can return to review and revise any data collected by the relevant system 10, 20, 30, 50.

As shown in FIG. 15 and FIG. 16B, the next step is to apply for Financial Aid (Step 2). The user is asked to supply an Expected Family Contribution (EFC). If the user has not submitted a FAFSA form and received a Student Aid Report (SAR) from the U.S. Department of Education, the user continues to the Financial Aid interview. The user completes the Financial Aid Interview and approves the FAFSA application. Optionally, the user prints CSS Profile worksheet. (The user completes the FAFSA and, optionally, the CSS Profile application off-line.) When the user returns to Step 1, the estimated EFC is filled in automatically. The user has the option of returning to Step 1 later and filling in the actual EFC. If the user has already submitted a FAFSA form and received a SAR from the U.S. Department of Education, the user fills in the actual EFC from the SAR. Step 2 is completed when user provides an estimated or actual EFC as shown in FIG. 16C.

After an estimated or actual EFC is provided, the user returns to Manage College Finances page to move on to the next step of the workflow. In FIG. 15 and in FIG. 16D, the next step is to evaluate your options (Step 3). During this step, the user selects one or more colleges of interest. As shown in FIG. 16D, a Cost field in the Cost Gap Calculator table is filled in automatically with amounts from the college profile for the colleges selected by the user. The user may edit the table to adjust the amounts supplied and to include additional costs and any awards offered by the school (or expected from the school). Ideally, the student has been accepted at one or more schools and uses the Cost Gap Calculator to compare actual costs and awards as shown in FIG. 16E. The total cost of attendance minus the value of any awards from a school equals the cost gap, the actual contribution the student and the student's family will need in order to pay for the selected school. Step 3 of the workflow depicted in FIG. 15 is completed when user selects at least one school. At this point, the user returns to the central CFM interface page.

It is likely that when evaluating different schools a cost gap will exist between the monies available and the cost for attending the institution of interest. Given this likely scenario, the next step is to meet the cost gap (Step 4) as depicted in FIG. 15 and FIG. 16F. If the student has a cost gap for one or more schools, then he or she can explore financing options for the college(s) of interest. Ideally, the user will be exploring options for schools where the student has been accepted.

In one embodiment, when used initially Step 4 directs the user to the Loan Preferences page. After the user has selected loan preferences, Step 4 contains the Review link, which returns to the Loan Preferences page, plus one or both of the following links: About Government Loans and About Private Loans. These additional lending options help a user meet the cost gap as shown in FIG. 16G. Step 4 is completed when the user has finished applying for loans.

The next step in the workflow is to evaluate loan preferences (Step 5). As show in FIG. 16H, the Loan Preferences page contains information on financing options. Once a user chooses to learn more about government and/or private loans, the user returns to Manage College Finances page. From the central interface, the user can obtain additional information about government loans (Step 6) or private loans (Step 7).

The Government Loans page, as shown in FIG. 16I, contains information about government loans and asks if the user wants to apply for a government loan. If the user answers, Yes, the user continues to the Opt-in interface and related process flow (Step 8). Similarly, if the user answers, No, the user returns to the Manage College Finances page.

If the user expressed an interest in private loans (Step 7), the finance manager would have directed them to a private loans page as shown in FIG. 16J. The Private Loans page contains information about private loans and asks if the user wants to apply for a private loan. If the user replies with Yes, the user continues to Opt-in page. In contrast, if the answer is No, the user returns to the Manage College Finances page.

The Opt-in step of the workflow (Step 8) shown in FIG. 15 is a mechanism by which a user agrees to share their personal information with various outside lenders. Specifically, in one embodiment of the Opt-in step, the user is asked if he or she agrees to share information with private lenders. If the user agrees, he or she continues to the Borrower Interview Step 9. In contrast, if the user disagrees, he or she returns to the Manage College Finances page.

If the user elects to participate in the borrower interview (Step 9) as shown in FIG. 15, one embodiment of this step requires that the student has been accepted to at least one college and has decided on the college to attend and that the user knows the amount of the loan requested. The user selects the college the student will attend and specifies the loan amount. If the amount exceeds the standard, based on the cost of attendance for the selected college, the application is rejected and the user remains on the college selection page. If the loan amount is acceptable, the user continues to the Borrower Interview. If the parent or student has entered information into the Financial Aid Interview, some fields may be pre-populated with user-supplied data. The user answers the questions in the Borrower Interview. If the user does not complete the Borrower Interview, he or she can return later and continue entering information. Answers are preserved from session to session. If the user completes the Borrower Interview, he or she continues to the Second Opt-in page.

As an added step in one embodiment, the user is asked to perform a second Opt-in (Step 10). Specifically, the user is again asked if he or she agrees to share information with private lenders. If the user agrees, he or she continues to Loan Comparison page. If the user disagrees, he or she returns to the Manage College Finances page. The final step in the work flow is to compare the results of the different lending possibilities this is achieved using loan comparison (Step 11). The Loan Comparison page presents a list of lenders as shown in FIG. 16K. If the user has selected Government Loans in his or her loan preferences, the loan options are described and the available government lenders are listed on the page. As shown, on the interface page, the user selects Learn More to see details about the lender and the loan. The user selects Apply to submit a loan application to the lender. If the user has selected Private Loans in his or her preferences, the available private lenders are listed on the page. The user selects Learn More to see details about the lender and the loan. The user selects Apply to submit a loan application to the lender.

### Loan Application Design

Aspects of the invention facilitate a map of the data that is generated by the college application process of the systems 10, 20, 25, 30, 50 such that the data that can be used by Financial Aid Interview and the Borrower Interview aspects of the invention.

The system loan application process pages can collect data not already collected in the Financial Aid Interview in a manner that is consistent with the business rules and data requirements of both the current www.teri.org application for private loans and partner Stafford and Plus loans for government lending partners.

Following a student or parent decision to opt-in and apply for a loan, the system passes XML data that matches the requirements of the system design to the required financial partners in real time using a web services approach that guarantees delivery (SOAP/HTTP).

Once a loan application file is received, the private or government loan partner systems are adapted to transform the XML data into the form needed by the current system and either 1) acknowledge application receipt on a web landing page in real time, or 2) send a branded e-mail acknowledging receipt to the loan applicant. This e-mail should contain two elements: Credentials (if needed) to login and check status and a toll-free number for customer service inquiries that is answered by the partner. The next step is to start back end loan processing to validate whether the borrower(s) are creditworthy and can borrow the amount requested for the educational purpose identified.

Aspects of the invention relate to a standard format and representation of a high school or community college letter of recommendation (LOR), and other application related documents, for consideration by a 4 year college or university admissions officer. In one embodiment, this standard format is organized using an XML scheme. Other data transmitted and processed using the systems and methods described herein can also be organized using XML and other data formats.

For example, in one embodiment, the XML based LOR document is structured in a manner that provides for optional inclusion of ranking and rating information as well and contact information, description of relationship to the applicant, and text for the recommendation itself. By using a structured format for this document type, LORs can be collected and transmitted so that a college that can consume them and accept the rankings and text in each document as usable data. This data can be stored natively in a student information system and/or customer relationship management system for review and analysis.

Present LOR processes require blind postal mailings of documents from LOR writers that result in either paper storage with related retrieval/confirmation costs or are received and imaged using a scanning system. Each LOR that is received in this manner must be also manually matched with a student's related application materials by a data entry person. The structured LOR and other formatted documents, such as applications (educational institution, employment, financial aid, scholarship and others), and transcripts, contain matching information and a unique identifier that can be used by college systems to perform an automated match. This unique identifier approach is useful because it can be used to perform a direct match with other application materials transmitted and processed using the systems and methods disclosed herein regardless of arrival date/time and sequence.

The invention relates to methods for simplifying the process of applying for a position with an entity, sending electronic transcripts, generate electronic course catalog data, and managing the financial aid process through a central portal. Generally, throughout the disclosure, the principle entity of interest includes, but is not limited to an educational institution or financial institution such as a college, a graduate school, a high school, a student loan provider, and a 529-plan provider. However, the scope of the invention and the appended claims can be extended to cover other application processes such as, for example, the insurance application process, the job application process, application for military service, or other application processes that represent a particular demographic of applicants.

The foregoing description of the various embodiments of the invention is provided to enable any person skilled in the art to make and use the invention and its embodiments. Various modifications to these embodiments are possible, and the generic principles presented herein may be applied to other embodiments as well.

It will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the invention.

Moreover, the processes associated with some of the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium later. Such a medium may include any of the forms listed above with respect to storage devices and may further include, for example, a carrier wave modulated, or otherwise manipulated, to convey instructions that can be read, demodulated/decoded and executed by a computer.

Software of the server and other modules herein may be implemented in various languages, such as, for example, ColdFusion, Ruby on Rails, ASP, ASP.NET, SQL, PL-SQL, T-SQL, DTS, HTML, DHTML, XML, ADO, Oracle database technology, JavaScript, JSP, Java, Flash, Flex, and C#. In addition, software at the application server may be added or updated to support additional device platforms.

A “computer” or “computer system” may be, for example, a wireless or wireline variety of a microcomputer, minicomputer, laptop, personal data assistant (PDA), wireless e-mail device (e.g., BlackBerry), cellular phone, pager, processor, or any other programmable device, which devices may be capable of configuration for transmitting and receiving data over a network. Computer devices disclosed herein can include data buses, as well as memory for storing certain software applications used in obtaining, processing and communicating data. It can be appreciated that such memory can be internal or external. The memory can also include any means for storing software, including a hard disk, an optical disk, floppy disk, ROM (read only memory), RAM (random access memory), PROM (programmable ROM), EEPROM (electrically erasable PROM), and other computer-readable media.

In some embodiments, the data processing device may implement the functionality of the methods of the invention as software on a general purpose computer. In addition, such a program may set aside portions of a computer's random access memory to provide control logic that affects the hierarchical multivariate analysis, data preprocessing and the operations with and on the measured interference signals. In such an embodiment, the program is written in any one of a number of high-level languages, such as FORTRAN, PASCAL, DELPHI, C, C++, C#, VB.NET, or BASIC. Furthermore, in various embodiments the program is written in a script, macro, or functionality embedded in commercially available software, such as MATLAB or VISUAL BASIC. Additionally, the software in one embodiment is implemented in an assembly language directed to a microprocessor resident on a computer. The software may be embedded on an article of manufacture including, but not limited to, “computer-readable program means” such as a floppy disk, a hard disk, a downloadable file, an optical disk, a magnetic tape, a PROM, an EPROM, or CD-ROM.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method of processing and routing applicant data, the method comprising the steps of:
collecting electronic profile data from a first applicant, the first applicant enrolled in a first institution, the electronic profile data comprising (a) a first grade point average associated with the first applicant; (b) first applicant identifier data; and (c) at least one test score;
automatically transmitting the electronic profile data for the first applicant in response to a first request, the first request originating from one of (1) a second institution or (2) the first applicant;
automatically generating an admission decision report with respect to the first applicant; and
displaying one of the (1) the profile data for the first applicant or (2) the decision report to a reviewing party associated with the second institution.

2. The method of claim 1, wherein the first institution and the second institution are selected from the group consisting of a high school; a community college; a 2-year post-high school institution; a trade school; a college; a university; a 4-year post-high school institution; a scholarship program; a graduate school; and an employer.

3. The method of claim 1, further comprising the step of accessing an electronic course catalog generated in response to historic transcript data to obtain a first set of course catalog data for the first student.

4. The method of claim 3, further comprising the step of calculating a second grade point average for the first applicant in response to the first set of course catalog data.

5. A method of processing academic transcript data, the method comprising the steps of:
transmitting electronic transcript data for a first student in response to a request, the electronic transcript data having an associated first grade point average;
accessing an electronic course catalog generated in response to historic transcript data to obtain a first set of course catalog data for the first student; and
calculating a second grade point average for the first student in response to the first set of course catalog data.

6. The method of claim 5, further comprising the step of making one of an admit, deny, or hold decision for the first student based on the second grade point average.

7. The method of claim 5, wherein the electronic transcript data is transmitted in an XML format.

8. The method of claim 5, further comprising the steps of:
collecting electronic application data from the first student;
transmitting the electronic application data to an educational institution; and
transmitting an electronic admit, deny, or hold decision to the first student.

9. A method of processing financial aid applications, the method comprising the steps of:
presenting a sequence of questions to an applicant using a computer based graphic user interface,
changing the questions in the sequence presented as a function of the answers given by the applicant, the questions developed in response to a plurality of financial aid applications;
populating a plurality of electronic financial aid forms using the answers provided to the sequence of questions; and
transmitting the plurality of electronic financial aid forms to their originating institutions.

10. The method of claim 9, wherein the method is implemented using a financial aid aggregator portal such that a process for submitting financial aid requests to a plurality of entities and a process of notifying an applicant of aid awards are performed using the portal.

11. The method of claim 9, further comprising the step of generating a hierarchical representation of financial aid awards on a per educational institution basis using a single portal having a portal interface.

12. The method of claim 9, further comprising the step of identifying financial aid awards on a per institution basis using a single interface.

13. A method of processing electronic transcript data, the method comprising the steps of:
receiving student transcript data on a periodic basis for a first institution;
identifying a plurality of courses in response to the student transcript data;
generating an electronic course catalog comprising a plurality of course entries, the course catalog accessible using an interface; and
updating the course catalog as new student transcript data is received.

14. The method of claim 13, further comprising the step of transmitting an alert to a second institution when the course catalog changes.

15. The method of claim 14, wherein the second institution is selected from the group consisting of a high school; a community college; a 2-year post-high school institution; a trade school; a college; a university; a 4-year post-high school institution; a scholarship program; a graduate school; and an employer.

16. A method of automating an application process, the method comprising the steps of:
collecting student identification information using a graphic user interface;
collecting student transcript data and student application data;
generating a first secure communication channel to transmit a portion of the student transcript data and student application data to a first server in response to a valid request;
formatting the transcript data such that it is suitable for use by a first database;
generating a second secure communication channel to transmit the portion of the student transcript data and student application data to the first database, the first database managed by an institution, and
notifying the first server when the transcript data has been received by the database.

17. The method of claim 16 wherein the valid request is verified using student identification information.

18. The method of claim 16, wherein the institution is selected from the group consisting of a high school; a community college; a 2-year post-high school institution; a trade school; a college; a university; a 4-year post-high school institution; a scholarship program; a graduate school; and an employer.

19. The method of claim 18, further comprising the step of scaling student transcript data using an electronic course catalog.

20. An automated student information system, the system comprising:
a database configured to store applicant profile data, the applicant profile comprising a first grade point average associated with a first applicant; first applicant identifier data; and at least one test score;
an electronic transcript processing module in electrical communication with the database, the electronic transcript processing module configured to receive an electronic transcript from the first applicant's enrolled institution; and
a student information system interface, the interface in communication with the database and configured to automatically retrieve and process applicant data to prepare an admit, deny, or hold decision report.

21. The apparatus of claim 20 wherein the enrolled institution is selected from the group consisting of a high school; a community college; a 2-year post-high school institution; a trade school; a college; a university; a 4-year post-high school institution; a scholarship program; a graduate school; and an employer.
